(19) United States
(12) Patent Application Publication
(10) Pub. No.: US 2011/0175371 A1
(43) Pub. Date: Jul. 21, 2011

(54) Flywheel system

(75) Inventor: Bill Gray, San Francisco, CA (US)

(73) Assignee: VELKESS INC., San Francisco, CA (US)

(21) Appl. No.: 13/008,292

(22) Filed: Jan. 18, 2011

Related U.S. Application Data
(62) Division of application No. 11/995,539, filed on Mar. 14, 2008, now abandoned.

(51) Int. Cl. H02K 7/18; H02N 1/00

(52) U.S. Cl. 290/1 R; 318/116; 310/300

(57) ABSTRACT

A flywheel system has an approximately toroidal flywheel rotor having an outer radius, the flywheel rotor positioned around and bound to a hub by stringers, the stringers each of a radius slightly smaller than the outer radius of the flywheel rotor. The hub is suspended from a motor-generator by a flexible shaft or rigid shaft with flexible joint, the flywheel rotor having a mass, substantially all of the mass of the flywheel rotor comprising fibers, the fibers in large part movable relative to each other. The motor-generator is suspended from a damped gimbal, and the flywheel rotor and motor-generator are within a chamber evacuatable to vacuum. An electrostatic motor/generator can also be within the same vacuum as the flywheel.

### CROSS REFERENCE TO RELATED APPLICATIONS

This application is a divisional of U.S. patent application Ser. No. 11/995,539, filed on Jan. 9, 2008, which application is incorporated herein by reference for all purposes.

### BACKGROUND

It is highly desirable to be able to store electrical energy for later use.

There are many technologies that are able to store and regenerate electrical energy, but few of these methods are able to do so cheaply enough to be economically useful in applications that are connected to large scale system such as utilities' electricity grids. All the few currently available technologies that are able to perform economically are limited in their usefulness by various geographical, geological, and/or topological requirements that limit their ultimate achievable capacity, and their proximity to potential users.

The inexpensive storage of large quantities of electrical power can allow generators, transmitters, distributors, and users of electricity to smooth large swings in their power requirements allowing for significant increases in fuel and capital efficiency. Beyond this purely economical value of inexpensive electricity storage, a very large environmental value has become apparent. CO₂ produced by fossil-fuel-based electricity generation is a major contributor to the problem of global warming. While there are numerous generation technologies in the market place that can produce large quantities of usable electricity without producing CO₂ and other pollutants as a byproduct, none of the currently known and readily expandable solutions is able to arbitrarily increase or decrease its output to match user demand. Technologies based on wind, solar, and tidal energy conversion are only able to generate electricity when these energy sources are available. Nuclear power is notoriously hard to rapidly increase and decrease, running far more efficiently when operated at a steady-state output. Because of these temporal limitations, these technologies are only able to serve a small portion of total electricity demand, and must rely on fossil-fuel generation to provide power at critical times. In order for these technologies to economically grow as a percentage of total system generation capacity they require very large increases in the capacity to store and regenerate electricity.

Much attention has been given in recent years to the notion of using a flywheel for such storage. The goal is to use electrical energy via a motor to accelerate a flywheel thereby converting the electrical energy into kinetic energy stored in the momentum of the flywheel. Once the electrical energy has been converted into kinetic energy one can optionally to permit time to pass during which the flywheel spins freely. Later, energy can be drawn down from the system by allowing the momentum of the flywheel to drive a generator or alternator. This slows the flywheel and converts its' stored kinetic energy back into electrical energy.

The energy storage flywheel is a very old idea that has been in widespread use for a long time. The electricity storage flywheel or electro-mechanical battery, like the one described above is also not a new idea and some flywheel based systems have been proven to be able to provide some high value services to grid connected applications such as frequency regulation and short term emergency power backup. Excepting the invention disclosed in this document, no flywheel energy storage system that the inventor is presently aware of is able to provide storage economically enough to be of widespread utility as a bulk energy storage solution.

The economic viability of a flywheel system is a function of many factors. Of these, the most important are capital costs of construction, conversion efficiency of the “spin up” and “draw down” processes, and the coasting efficiency or how much energy is lost while the flywheel is in a charged state but power is neither being applied to or drawn from it.

The kinetic energy stored in the flywheel is ½Iω² where I is the moment of inertia of the flywheel and ω is the angular velocity of the flywheel. In order to maximize this equation per unit cost, it is generally desirable to form the flywheel rotor material into a shape that maximizes the moment of inertia for a given amount of material. One of the most efficient flywheel rotor shapes then is a ring or hoop of material.

There are a multitude of design issues that must be considered in the construction of a flywheel. Those include, but are not limited to material cost, fabrication cost, dynamic stability, internal friction, bearing technique and arrangement, motor/generator technique and arrangement, and enclosure.

One known flywheel system is the “flexible flywheel” system described and partially tested by Vance and Murphy (the “Vance flywheel”), described in J. M. Vance and B. T. Murphy, “Inertial Energy Storage For Home or Farm Use Based on a Flexible Flywheel”, 1980 Flywheel Technology Symposium, October, 1980, Scottsdale, Ariz., cosponsored by U.S. Department of Energy, American Society of Mechanical Engineers, Lawrence Livermore National Library, Pages 75-87. This design suspends a doughnut-shaped bundle of rope (serving as a flywheel) by means of a number of supporting ropes from a motor which is itself suspended from a special non-axially symmetric damped gimbal system. The Vance system was found to have various desirable properties.

When this system is accelerated by the motor rapidly so that the supporting ropes “twist up” on themselves to form a sort of flexible shaft, the system is found to be entirely self-balancing and self-stabilizing. This is a major advantage over most other described flywheel systems.

Additionally, because the individual fibers of the Vance flywheel rotor are not bound to one another in a rigid matrix, the flywheel rotor does not suffer from the large internal stresses and internal friction that limit many other flywheel designs. In a rigid flywheel made out of isotropic materials, a composite fiber/resin matrix, or any other rigid or semi-rigid material/materials, hoop stresses form as a result of the angular acceleration experienced by the flywheel rotor material when the flywheel rotor is at speed. These stresses are considerably larger at the periphery of the flywheel rotor than at locations closer to the axis of rotation. All materials elongate when subjected to stress and those subjected to greater stress elongate more than those subject to lesser stress. Because of the stress distribution that develops in a rotating body, inconsistent elongation occurs between different parts of the flywheel rotor at different radial distances from the axis of rotation. In flywheel rotor systems that are rigid or semi-rigid, these differences can cause large shear stresses to develop between portions of the flywheel rotor. These stresses can cause the destruction of the flywheel rotor. This problem is the subject of much work in the flywheel field. Because the Vance flywheel is flexible and its fibers are not rigidly affixed to one and other, they are able to move slightly with respect to one and other. Thus, the large shear stresses that are problematic in many contemporary flywheel rotor designs do not develop and are consequently not an issue.

The self-stabilizing, self-balancing, and shear-relief properties of the Vance flywheel when coupled with the system's efficient distribution of mass in the flywheel rotor, ease of manufacture, and low bearing loading makes this configuration very interesting.

The device was not fully tested however, before the project was disbanded. The device suffers from some crucial limitations that preclude its use in as a deployable energy storage solution as described. The most critical limitation is that the system becomes wildly unstable if and when the supporting ropes are allowed to untwist. In order for any flywheel to operate at high speed and with low coasting losses, it must operate in a reasonably good vacuum and with a highly efficient bearing system to avoid large windage and frictional losses. In this environment, while coasting, there is no (or very little) torque being applied to the flywheel rotor and the force of gravity acts to untwist the supporting ropes. When the supporting ropes become unwound, the flywheel rotor loses its self-balancing and self-stabilizing properties and becomes wildly unstable, a condition that is not acceptable for deployable systems. This untwisted configuration is also encountered in any situation where the torque on the flywheel rotor is actively reversed. In this case the supporting ropes are forced to fully unwind and then wind again requiring the system to pass through the unstable “untwisted” configuration. This situation can occur when, for example, the system is put directly into the draw-down mode from the spin-up mode. While the period of instability in such an instance is often quite short and generally will not crash the system, it is violent and creates considerable uncontrolled stresses on the system that are not desirable in any high availability application.

The Vance flywheel is also critically limited in the amount of torque that can be applied to the system.

To see this, consider an analogy to a common child's toy, a rubber-band-powered balsa airplane. At first, the rubber band is totally loose and untwisted. When one starts to wind the propeller, the rubber band twists up. At some point, the rubber band will get so twisted, it enters a second-order twist that is coarser than the initial first-order twist. The twisted rubber band twists back on itself creating a second layer of twist. The first portion of second-layer twist looks like a little knot. If one keeps winding, a continuous row of knots will end up covering the entire length of the rubber band. Once this row of knots uses up the whole rubber band, if one keeps on winding, another larger knot will start, representing a third-order twist, and this third row of large knots will start to grow. Generally once one has the third level of twist about half-way across the rubber band, the rubber band will break at one of the ends.

If instead of a rubber band being twisted between two fixed points one had a bundle of rope, hanging down with a counterweight (or in this case a flywheel rotor) this rope could keep on twisting up on itself. Because this system is not fixed at both ends, instead of adding more tension to the system the rope just shortens up as it grows wider with each new twist. Rapidly, the rope shortens to the point that it is no longer a flexible loose stabilizer but rather begins to approximate a short rigid link. At some point on this continuum the flywheel becomes unstable either from the loss of length or from the loss of flexibility. From this it may be seen that there is a strict and rather low limit to the amount of torque that one can apply to the system before it becomes unstable. Apply too much torque and the twisted ropes will twist up on themselves again and again shortening their effective length with each new layer of twist until the flywheel becomes more or less rigidly attached to the motor/generator and loses its ability to self-balance. The flywheel becomes wildly unstable.

This torque limitation is quite significant because it limits the rate at which power can be injected into and extracted from the system, limiting the system's utility. This can also be a safety issue in cases where it is desirable to discharge the flywheel as rapidly as possible.

The present invention is a significant advancement on the Vance flywheel design. By incorporating a novel super-circular flexible flywheel rotor configuration that incorporates a rigid shaft with a flexible coupling, the present invention incorporates all of the benefits of the Vance flywheel, but eliminates the twisted supporting ropes. This allows the machine to coast and reverse direction of torque in a vacuum without ever compromising the stability of the system. Additionally, the present invention drastically increases the amount of torque that can be applied to the flywheel rotor. This in turn dramatically increases the amount of energy that can be put into or drawn off of the system in a given period of time.

Another successful approach to the internal friction/shear stress issue is the “bare filament” or “sub-circular” flywheel rotor as described in G. Genta “Kinetic Energy Storage: Theory and Practice of Advanced Flywheel Systems” Butterworth-Hienemann Ltd. (February 1985) and in D. W. Rabenhorst, T. R. Small, and W. O. Wilkinson “Low-Cost Flywheel Demonstration Program” The Johns Hopkins University Applied Physics Laboratory—Report Number DOE/EC/1-5085 April 1980.

This system uses a hoop of flexible fibers that are strung over a series of compressively stressed spokes or a solid form with a sub-circular formation FIGS. 23 & 24. In the sub-circular spoked configuration the hoop of fibers has a radius that is smaller than that of the spokes 70 so that the hoop 71 is forced into a shape that is smaller than the circle that would be determined if hoop 71 and the spokes 70 had equal radii. In a sub-circular flywheel rotor as described by Rabenhorst a solid core is used that is cut into a sub-circular shape rather than Genta's spoke core but the approach, goals, and function of the system are ostensibly the same. When the sub-circular flywheel rotor is spun, the centrifugal forces will work to force the flexible fibers into a perfect circle. Because the spoke or core system will not allow the fibers to fall into the balanced circular form that it they would naturally prefer to, they experience a compressive force that increases with the flywheel rotor's speed of rotation. Because of this interaction, the fibers of the flywheel rotor are adequately controlled to provide reasonable flywheel rotor stability, but this configuration does not require that the fibers or filaments be rigidly affixed to the core, spokes, or each other. This allows the “bare filament” or “sub-circular” flywheel rotor to avoid the internal friction and shear stress issues previously discussed. The number of spokes 70, or virtual spokes as can be found in the cored flywheel rotors, can range from a minimum of 2 spokes 70 to some very large number that can be determined by experimentation with specific configurations.

These “bare filament” or “sub-circular” flywheel rotors as discussed can be balanced reasonably well, but shifting of the filaments with respect to each other limits their utility in standard rigidly supported flywheel systems as these flywheel rotors are dynamic in and of themselves and so will tend to lose balance as the system is cycled. Additionally, these flywheel rotors require relatively expensive materials and techniques for the fabrication of the spoke 70, hub 73, or core. Inexpensive materials such as plywood have been successfully tested by Rabenhorst, but their reliability was deemed too low, and their tenancy to “out-gas” into the vacuum environment requires the system to incorporate an active vacuum maintenance system such as a diffusion, ion, turbo, or sorption pump at additional fabrication expense and energy overhead. Such a system for active maintenance of vacuum is also a wear and/or maintenance item.

The present invention uses a super circular format to achieve a similar, but superior and less expensive result. By replacing the compressive spokes 70 or core of the sub-circular flywheel rotor with shorter tensile stringers 11, a “super circular” form can be achieved in the filament hoop 10 (FIGS. 25 & 26). The tensile fibers of the stringers 11 can made of the same or of a different material as the main filament hoop 10. In the super-circular flywheel rotor, the tensile forces in the stringers grow with increasing rotational speed and tend to work to keep the small internal hub 12 stably aligned with the axis of rotation of the hoop 10. This stabilizing force increases with increased rotational speed. While the stabilization of this system is not as perfect at low speed as might be achievable with a rigid member, properly tuned it is plenty good enough to yield more than adequate stability. Because inexpensive tensile materials that are vacuum compatible are readily available, the super circular flywheel rotor can be manufactured at considerably lower cost than can a sub-circular flywheel rotor of equivalent capacity. Also, the fabrication techniques require from the construction of the super circular flywheel rotor are very simple which also considerably reduces fabrication cost.

Additionally, when used in conjunction with the Vance flywheel's gimbal system, the self-balancing qualities of that system can be realized with either the super or sub circular bare filament flywheel rotor, further reducing cost and increasing system reliability.

It would be extremely desirable if a flywheel system could be devised which avoids the drawbacks of the Vance flywheel and the drawbacks of other flywheel designs, and yet which preserves other benefits of a flywheel. It would also be desirable if inexpensive materials could be used. Such a system would offer the prospect of efficient and environmentally friendly storage of electrical energy.

A further concern in the design of a flywheel system for storage of electrical energy is the manner in which energy is pumped into the flywheel, and the manner in which energy is extracted. Many ways of injecting energy into the system, and extracting the energy, are inefficient, expensive, or bulky. Some of these ways are poorly suited to the physical environment to be employed here (vacuum).

It would be extremely desirable if a flywheel system could be devised which permits inexpensive and efficient injection and extraction of energy, and in which the injection/extraction mechanism is not too bulky and works well in vacuum.

The novel flywheel rotor and gimbal system 21 previously described can be used in conjunction with a wide variety of motor/generator technologies to inject and extract energy from the system including but not limited to pneumatic turbines, hydraulic turbines, squirrel cage induction, permanent magnet induction, brushed DC induction, universal, poly-phase, homopolar, and electrostatic motor/generators. As stated earlier, major considerations in the design of energy storage flywheel systems are material cost, fabrication cost, charging efficiency, discharging efficiency, and coasting efficiency and must be compatible with a vacuum environment. Many of the previously mentioned motor/generator systems, while usable in this system are not optimal for one of more of these reasons.

In order to minimize coasting losses, some form of motor generator that does not require a physical connection between the stator and the motor/generator rotor is desirable. Additionally energy dissipation should be minimized, particularly in a vacuum environment and especially when a non-contact bearing system such as an active magnetic bearing is used, energy dissipation in the motor/generator rotor must be minimized as heat buildup on the motor/generator rotor will dissipate quite slowly.

For these reasons, coupled with low manufacturing and materials costs, we have chosen to develop a novel “floating rotor” electrostatic motor generator that has many great advantages including no required electrical contact between motor/generator rotor and anything else, very low energy dissipation in the motor/generator rotor, very low energy dissipation overall, very high efficiency, high reliability, vacuum compatibility, and low cost of materials and fabrication techniques.

Most readers are accustomed to motors and generators that use magnetic fields created by either magnetic induction or a combination of permanent magnets and magnetic induction for the conversion from electrical energy to rotational energy (in a motor) and for the conversion of rotational energy to electrical energy (in a generator or alternator). This approach to electric motors and generators has many advantages that make such devices very attractive for most applications. Those advantages are primarily high power to weight ratio, high power to volume ratio, relatively high efficiency, and compatibility with a wide range of devices that are presently commercially available.

These electro-magnetic motors can readily and successfully be used with the super circular flywheel rig that has been described in this document. But these motors, while extremely useful and widely adopted, suffer several disadvantages in the flywheel application that can be avoided with a different approach to the motor/generator problem. Those disadvantages are energy dissipation and high expense. Energy dissipation in electro-magnetic motors generally come from 5 sources, namely windage, friction, joule heating, core hysteresis, and eddy current heating.

Windage can also be called aerodynamic loss and is the loss that any moving or rotating body experiences as it moves through an atmosphere. This issue can be almost entirely eliminated by placing the system in a vacuum, the higher the better.

Friction generally comes from one of two places. Firstly, all bearing systems that are not “non-contact” systems will have surfaces that are in contact with one and another and will generate frictional losses when the bearing is spun. In many electro-magnetic (and electro-static) motor designs, the spinning rotor must be physically and electrically connected to some sort of electrical power system. In this case the most widely adopted solution is to use a brush or a series of brushes that run along some surface of the rotor to make a physical connection across which electrical power can flow. The brushes universally cause frictional losses in the system.

Joule heating is heating that occurs when current flows through a wire and is calculated by the equation I²R. Because electro-magnetic motors must use coils of wire to create the electro-magnets that are fundamental to their operation, joule heating is an unavoidable result. Joule heating can be minimized at a given power level by the use of a thicker wire, but this generally results in greater expense and this solution is limited by the geometry of the motor system.

Hysteresis losses occur in the soft magnetic core materials that are used in electromagnetic motors to increase magnetic power and concentration. When a magnetic field running through a soft magnetic material is reversed, it requires some energy to reorient the magnetic carriers within that magnetic material. This required reversal energy is called hysteresis. This energy is dissipated as heat. It can be entirely avoided by designs that do not use soft magnetic core materials which are generally called “air-core” designs, but these designs require significantly more amp-turns in their coils in order to generate the same power levels as standard cored motors and so are generally subject to significantly higher joule heating losses and/or expense.

Eddy current losses occur as a result of induced eddy currents in any conductive material exposed to a changing magnetic field. This effect is described by Faraday's Law and used to great effect in various electro-magnetic systems such as the design family that is generally referred to as the squirrel cage induction motor. Despite the usefulness of eddy currents in many designs, these currents can be quite substantial and are subject to joule heating and are hence a source of losses.

In the case of the flywheel described herein, windage losses will be reduced to a minimum by operating the device in a vacuum. Frictional losses will be minimized through the use of non-contact or other specifically engineered bearing systems. Joule, hysteresis, and eddy-current losses though will be tough to significantly reduce beyond a certain level if electro-magnetic motor/generators are used. It should be noted that some electro-magnetic designs can optimized to reduce the effect of these types of loss in the coasting state of the flywheel. One such design is described in P. Tsao, M. Senesky, and S. R. Sanders, “An integrated flywheel energy storage system with homopolar inductor motor/generator and high-frequency drive,” IEEE Trans. Industry Applications, vol. 39, no. 6, pp. 1710-1725, November 2003. But these sources of loss are still very much present when the motor/generator is active, and the costs of the materials and fabrication methods required to construct such a motor-generator are prohibitive given the current state of the art in manufacturing technique and prevailing market prices for materials.

As will be appreciated, it is also possible to convert electrical energy to rotational energy by means of electrostatic fields, and to convert rotational energy to electrical energy by means of electrostatic fields. This approach to the motor/generator problem is not subject to or radically minimizes joule, hysteresis, and eddy-current losses because it requires neither high currents nor magnetic fields. These designs generally achieve highest power at high voltages, the high the better, and can be made to be extremely efficient. Even though these designs generally are unable to meet electro-magnetic designs in terms of power/unit volume which is a very important metric in many applications, these devices if properly designed can meet or beat electro-magnetic solutions in power/unit cost which is of great significance to the flywheel application. Additionally, some of these designs can be extremely efficient.

In the flywheel application, because the hysteresis and eddy-current losses have been eliminated by the use of electrostatic designs, the only remaining sources of system loss are windage, friction, and joule losses. Joule losses are radically reduced by the use of high voltage. Power can be determined by the equation P=VA. This shows that as the operating voltage of a system increases at a given power level, the required current for that power level falls linearly. As current falls, joule heating as determined by the equation I²R falls as exponentially. Systems operating at a voltage of 10 k volts will experience approximately 10,000× less joule heating than a system of equal power level operating from a voltage of 100 volts. In practice, operating voltages for electrostatic motor-generators can easily be far higher than 10 k volts.

As stated before, windage losses can be minimized by running the apparatus in a vacuum.

Most electrostatic motor and generator designs require both the motor/generator rotor and the stator of the device to be electrically connected, at least intermittently, to a source of electric power or ground. Many of these devices use a phenomenon called corona to place charge on or remove charge from one or more surfaces of the motor/generator rotor during the system's cycle. Because in the flywheel application it is desirable to reduce windage loses and therefor desirable to run the system in a vacuum, corona is not an effective method of transmitting charge and power. The other typical method of electrically connecting to the motor/generator rotor section of an electrostatic device is with a brush. Obviously the friction that such a brushed system would create is undesirable. It is desirable to have and electrostatic motor/generator where no physical contact to the motor/generator rotor is required.

An electrostatic generator that solves this problem was described in Sanborn F. Philp, “The Vacuum-Insulated, Varying-Capacitance Machine”, IEEE Transactions on Electrical Insulation, Vol. EI-12, No. 2, April, 1977.

FIG. 20 shows, in plan view and cross-sectional view and schematic view, a conceptual electrostatic generator as proposed by Philp. Rotor 41 and stators 42 define a variable capacitance 35. Rotor 41 rotates on shaft 43. In this embodiment it is assumed that electrical contact is made to the rotor 41, for example by means of conductive brushes.

As the shaft 43 rotates, the capacitance 35 varies between minimal and maximal values. Philp proposes to provide a negative excitation voltage at 31. The diodes 36, 37 are such that charge gets pumped toward node 34. In this way rotational energy at shaft 43 is converted to electrical energy at node 34. The conversion efficiency can be very high, as the chief losses (bearing friction, heat developed in the diodes, and windage for the rotor) can be readily reduced to very low levels.

In describing the floating rotor device as distinct from typical, non-floating variable capacitance machines, Philp says “Since the rotor [in a brushed system] is one electrode, a brushed connection must be made thereto, and this brush connection is, in a typical DC application, the means whereby an excitation voltage is applied. While the average power supplied by the source of excitation is zero, the currents passing through the brush connection are of the same magnitude as the full machine current. A different form of the electric machine, for which no brush connection is required, is shown in [FIG. 4]. This will be called a ‘Floating Rotor’ (FR) machine. In the FR machine, the stator assemblies A [42c] and B [42d] constitute distinct electrodes, between which exists the machine voltage. The varying capacitance is that between A and B. The rotor is insulated from A and B [by vacuum]. When the rotor is in such a position that its blades lie completely within the stators A and B, the electric capacity, C_{AB}, between A and B has its highest value. This capacity is the result of two capacitances in series, viz., stator A-to-rotor, and rotor-to-stator B. As the rotor turns on its axis, the rotor-to-stator capacitances change, and therefore also the resultant capacitance C_{AB}. When the rotor is in such a position that its blades lie completely outside the stator structure, C_{AB} has its minimum value, which is in fact only the capacity due to fringing fields between the edges of the stator and the rotor.”

### SUMMARY OF THE INVENTION

A flywheel system has an approximately toroidal flywheel rotor having an outer radius, the flywheel rotor positioned around and bound to a hub by stringers, the stringers each of a radius slightly smaller than the outer radius of the flywheel rotor. The hub is suspended from a motor-generator by a flexible shaft or rigid shaft incorporating a flexible joint, the flywheel rotor having a mass, substantially all of the mass of the flywheel rotor comprising fibers, the fibers movable relative to each other. The motor-generator is suspended from a damped gimbal, and the flywheel rotor and motor-generator are within a chamber evacuatable to vacuum. An electrostatic motor/generator can also be in the same vacuum as the flywheel.

### BRIEF DESCRIPTION OF THE DRAWING

The invention will be described with respect to a drawing in several figures.

FIGS. 1-3 are differing perspective views of an exemplary embodiment of flywheel system aspects of the invention.

FIGS. 4-19 are views of exemplary embodiments of motor/generator aspects of the invention.

FIG. 20 shows, in plan view and cross-sectional view and schematic view, a conceptual electrostatic generator as proposed by Philp.

FIG. 21 shows, in schematic view, an exemplary motor-generator according to the invention.

FIG. 22 portrays in schematic view an exemplary three-phase motor-generator according to the invention. Variable capacitances 35a, 35b, 35c may be seen, each for example coming from rotor plates such as those shown in FIGS. 13-16. Each phase has its respective parasitic capacitance 53a, 53b, 53c. Switches and diodes are shown which correspond to those shown in FIG. 21.

FIG. 23 shows a perspective view of a Genta style sub-circular flywheel rotor system 72, rigid spoke 70, filament hoop 71, and central hub 73.

FIG. 24 shows a plan view of a Genta style sub-circular flywheel rotor system 72, rigid spoke 70, filament hoop 71, and central hub 73.

FIG. 25 shows a perspective view of a super circular flywheel rotor system 74 of the present invention, filament hoop 10, stringer 11, and hub 12.

FIG. 26 shows a plan view of a super circular flywheel rotor system 74 of the present invention, filament hoop 10, stringer 11, and hub 12.

### DETAILED DESCRIPTION

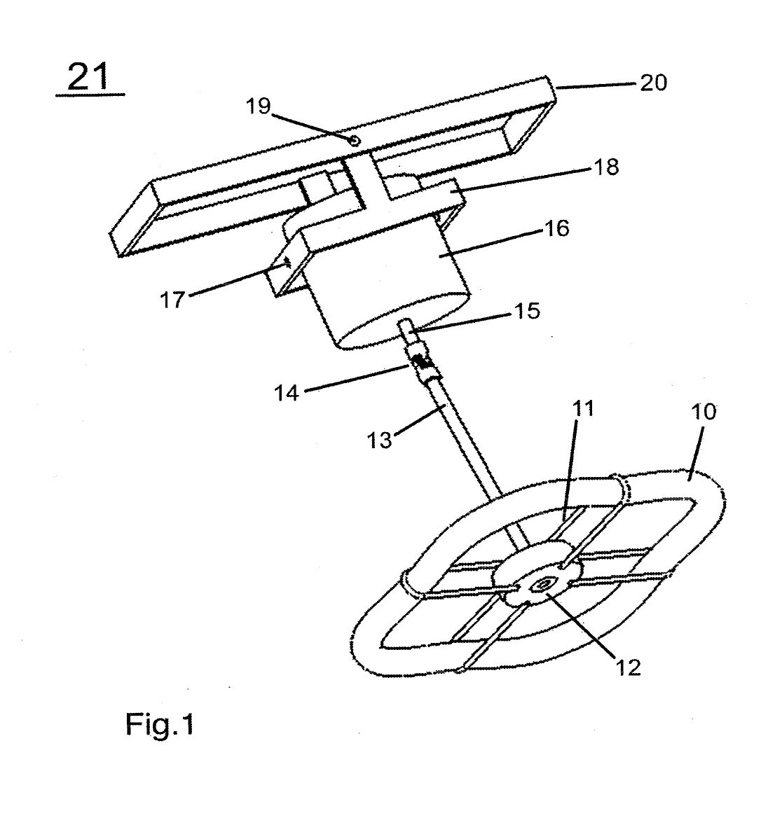

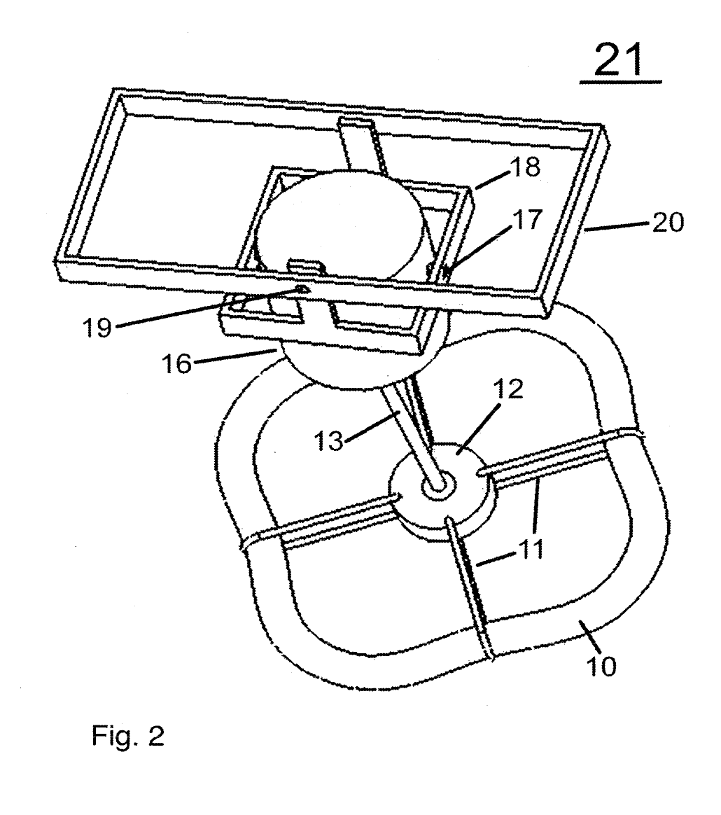

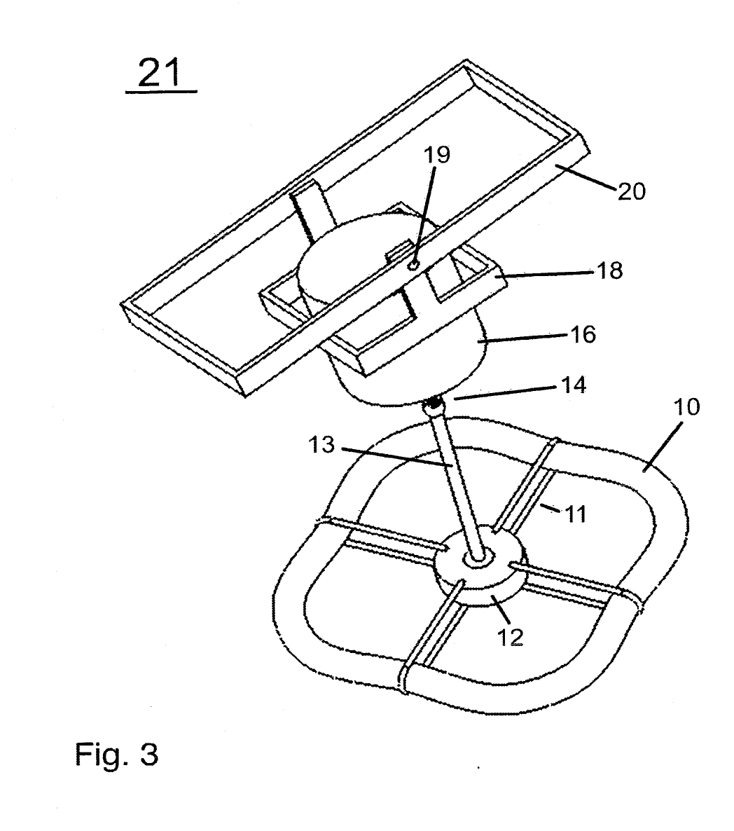

FIGS. 1, 2, and 3 are perspective views of an exemplary embodiment 21 of the invention. The system of the invention has been tested and has been found to be excellently stable and be able to endure all the torque that the test system can provide.

The twisted ropes of the Vance flywheel system have been replaced by a shaft 13 that is attached to the motor/generator 16 by a universal joint 14. The exemplary attachment at 14 is a universal joint, but in fact any variety of flexible couplings can be used here. For simplicity, maximum torque, and minimal expense, a steel shaft 13 and a common universal joint 14 have been put to use. A bellows coupling could be used. A rubber coupling, or a fully flexible shaft made out of a suitable material, could also be used.

The flywheel rotor main body 10 in the figures is actually a bundle of tensile fibers that form a hoop or doughnut or shape that approximates a torus. Like the Vance flywheel, no bonding agent needs to be used on the fibers, but a bonding agent can be used if desired, provided that the bonding agent does not constitute a rigid or semi rigid matrix that is incapable of relieving shear stresses that may develop between the fibers. The stringers 11 are short when compared with the radius of the body 10, so that the centrifugal force in the body 10 will pull out on the stringers 11 during spinning, thus tensioning the stringers 11. This tension in turn provides stiffness to the central hub 12 and resists any forces that might encourage the hub 12 to choose a different axis of rotation than that of the body 10. Flywheel rotors of this construction can be called “super circular”

This effect is not perfect of course, but is good enough to maintain stability over a wide range of rpms (a wide range of angular velocities) that have been tested, and stability improves with greater speed (energy). The exact ratio of the stringer length to hoop radius is not set in stone, but rather may be optimized to take full advantage of the properties of the materials used.

In testing a rigid bonding agent has been used to bond all of the fibers of the hoop to one another at the location where the stringer meets and attaches to the hoop. This situation was not found to have any negative effect on the shear relief performance of the flywheel because the volume of the hoop that was bonded was a small percentage of the overall hoop volume and the angular portion of the hoop that was bonded was a small percentage of the overall hoop. This arrangement is substantially parallel to an arrangement wherein the stringers are allowed to wrap once or more around the hoop cross section such that the stringer leaves the hub, wraps once or more around the hoop body and returns again to the hub. In a flywheel rotor of this construction, it can be seen that as the stringers experience tensile loading, they will impart a strong compressive force onto the fibers of the hoop at their point of attachment. In this case, the friction that results from this compressive force precludes the fibers from moving with respect to one another at the point of attachment of the stringer, but does allow them to move over the vast majority of the hoop circumference. This arrangement had no appreciable negative effect on the shear relief capability of the flywheel rotor overall and did not have any appreciable negative effect on performance.

Also important to note is that the hoop of the super circular flywheel rotor need not have a circular cross section. Hoops of square, rectangular, elliptical, or random cross section may also be used. Flexible cylinders of material can also be used as the hoop. The stringers need not pass around the out side of the hoop, but can pass directly through it if such a geometry is preferable.

Universal joint 14 connects the shaft 13 with a motor-generator shaft 15 of the motor-generator 16. Motor-generator 16 is, in this embodiment, held on bearings 17 to gimbal 18, which is in turn held on bearings 19 to frame 20.

It is important to note that the bearings of the gimbal 17, 19 require some dampening. In our test rigs we have either used very performance bearings, or we have loaded the bearings with a heavy vacuum compatible grease to provide some dashpot or dampening function. The self-stabilizing effects of the gimbal will not be realized without some measure of damping. Any damping method can be used here, we have also successfully experimented with magnetic eddy-current type damping. It is also worth pointing out that this damping constitutes an energy dissipation in the form of heat and that any designer of a future system ought to be aware of the requirement to dissipate this heat effectively. In our test rigs we have found that black body radiation has been sufficient to dissipate this energy, but it should be remembered as a design concern as some arrangements or materials may not be so forgiving.

It should also be noted that it is not required that the gimbal have 2 axes. A successful single axis gimbal is described in John M. Vance “Design for Rotordynamic Stability of Vertical-Shaft Energy Storage Flywheels” 2^{nd} International Energy Conversion Engineering Conference, 16-19 Aug. 2004, Providence, R.I. Though this single axes gimbal successfully stabilizes the system, it does not protect the bearing system of the flywheel from excessive loading in both axial directions. In the interest of high efficiency, long life, bearing system cost reduction, and tolerance to disturbances initiated from any direction, the non-symmetrical 2 axis damped gimbal is preferable to the single axis configuration.

This super circular configuration (a toroid main body 10 held by a number of stringers 11 relative to a hub 12) offers its benefits in a variety of flywheel systems, and is not limited to the particular type of system depicted here where the flywheel is pendularly suspended from a damped gimbal-supported motor/generator.

In the exemplary embodiment, the motor/generator 16 is in the same vacuum enclosure as the flywheel rotor 10.

The main body 10 can be made from the cheapest material that can be gotten to work in a vacuum. The two metrics that pretty much all previous investigators are focused on are Energy/Mass ratio or Energy/Volume ratio. There are good reasons for this, but in this application those metrics don't make a bit of difference. Our metric is Energy/Capital Cost. This is the real importance of the flywheel rotor that the inventor has developed. It will be able to be made of a broad variety of really cheap materials where the ratio of Tensile Strength/Cost is maximized. Materials that do not meet this maximized ratio are also fully applicable to the design, but they may not minimize the overall cost of the flywheel system.

Many investigators have, in the past, sought to maximize an Energy/Mass ratio or an Energy/Volume ratio. Actual experience, however, suggests that it is better to maximize Tensile Strength/Dollar. By this we mean the tensile strength of the material from which the body 10 is fabricated. Basic run-of-the-mill E-glass fiber glass works economically. Steel wire or cable works well but proves not to be particularly economic. Other candidate materials are basalt fiber, hemp, manila hemp, bamboo, birch, sulfate, paper, wood, sisal, jute, burlap, linen, flax, other cellulose fibers, various polyolefins including polyethylene, plastic, polyester, acrylic, aramid fiber, carbon fiber, carbon nano-tubes, other high strength nano-tube materials, and just about any cheap strong fiber one can find.

It should be pointed out that the number of stringers can vary considerably. Actual experience with 2, 3, 4, 5 or 6 stringers shows that each of these numbers works fine. It is contemplated that a larger number of stringers will also work well. Even a single stringer may be workable.

In contrast to the Vance design, the present design does not have such a low limit as to the maximum torque that may be applied. With the present design, the ability to apply greater torque to the system allows one to vastly increase the rate at which one can add and remove energy from the system. This is extremely advantageous.

It will also be appreciated that even if there were no desire to have the ability to apply a great torque to the flywheel rotor, this feature of a rigid connection suspending the flywheel rotor will significantly reduce the amount of time necessary to safely stop the system in the event of an accident or other event (as compared with the time required to bring a flywheel rotor to a halt if it is suspended by twisted rope members as in the Vance system).

The system described here can make use of any of a very wide range of types of fiber, including relatively inexpensive fibers. A chief factor in fiber choice beyond just strength/cost is that it is desirable that the fiber be vacuum compatible, which in this context means that it is capable of achieving a low pressure equilibrium of sufficient evacuation to allow the device to function and to the extent that the material evaporates or sublimates, it does not create an environment that would unduly corrode or otherwise harm the other components of the system. As mentioned above, the key metric appears to be Energy Stored/Unit Cost. In the case of fiber material we need to maximize Tensile Strength/Unit Cost.

As mentioned above, internal shear stresses within a flywheel rotor can tear it apart. In this super circular flexible flywheel, one principle advantage is that these stresses never develop to any significant degree. The fibers are free to move with respect to one and other and so that any significant shear strain is relieved. A further advantage of this system is that it is cheaper because of the lack of the need to process fiber materials and the lack of need for any resin in fabrication.

It is important, however, to consider the possibility of self-abrasiveness in the fibers of the flywheel rotor. It is desirable to select a fiber material that is not substantially self-abrasive. The effect of different rates of self abrasiveness in fibers will be a subject of further testing.

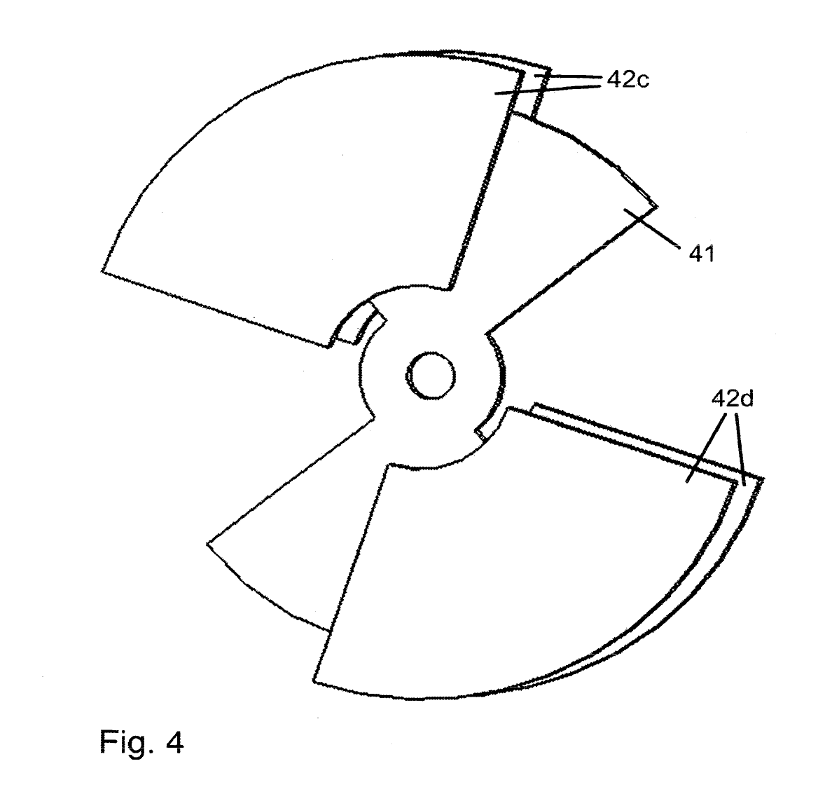

FIGS. 4-19 are views of exemplary embodiments of motor/generator aspects of the invention.

The Philp Varying-Capacitance Floating Rotor Machine was only ever conceived of as a generator of high voltage DC power. In the flywheel application, it must be modified to work as a motor as well as a generator. The first modification is to add (in parallel to the diodes that Philp describes) a switch that is capable of switching the requisite high voltage at a high frequency. Secondly, a system for determining the angular position of the motor/generator rotor is added. This system can be any one of a large number of non-contact position sensing apparatus, but in our case we have been working primarily with a reflective optical sensor system. This position sensing system can either feed data into a computer or microprocessing unit of some sort, or can be linked directly to the switches so as to activate them at particular times in the motor/generator rotor cycle allowing the system that was once only able to function as a generator to function also as a motor.

One way to understand the theory of operation for an electrostatic motor is in terms of the energy stored in a capacitor. Such a capacitor is seen for example in FIG. 4 which shows in perspective view a conductive motor/generator rotor plate 41 which rotates in relationship to conductive stator plates 42. In an exemplary embodiment the conductive plates 41, 42 are metal or are other material coated with a conductive surface. At one point during rotation the capacitance is at a maximum (when each lobe of the motor/generator rotor is fully within lobes of the stator). At another point during rotation the capacitance is a minimum (when each lobe is fully outside of any lobes of the stator). Parasitic capacitance 53 will raise the achievable capacitance minima. This is of concern because this device gains power as the variability of the capacitance grows, and cannot function if the variability of the capacitance is less than ½ the maximum capacitance.

Capacitance is, of course, defined by Q=CV where Q is the charge stored in the capacitor and V is the voltage developed across the plates of the capacitor. Here, C is quite variable.

With this motor arrangement, there is the problem of starting the system from a dead stop. It is possible that the motor/generator rotor came to rest in position where power cannot be added. Furthermore, it is possible that motor/generator rotor can come to rest in a position where power can only be added in the opposite direction of rotation from that which would be deemed by a designer or operator to be desirable. In this case some method must be devised to get the motor started or alternatively to bring the motor/generator rotor to a stop in only a advantageous position. It is possible to program the previously mentioned microcontroller system to cause the motor/generator rotor to stop only in advantageous positions. Additionally, it is also possible to construct a contact device that when activated will cause the motor/generator rotor to stop at a predefined angular position. The former method is complex and does not allow for a disturbance of the system that might change the angular position of the motor/generator rotor accidentally. The latter method is simple, but crude and may cause undesirable strain on delicate motor/generator rotor parts.

A third approach is to add one or more additional phases to motor/generator. Additional phases can be arranged so as to eliminate all positions of the motor/generator rotor at which no power can be added to the system. Furthermore they can be arranged so that an initial direction of rotation can be chosen at every possible resting position of the motor/generator rotor.

It is not necessary that the phases all be equal in potential power or size. In fact it may be advantageous in some applications to have the additional phases be of the minimum size and power necessary to insure proper starting of the motor. Conversely it may also be advantageous in some applications to have the phases be of as close to the same size and power as possible. A wide range of ratios of size and power between the various phases of the system may be desirable to meet specific design criteria in specific applications.

Another method for starting the motor/generator is to supply some outside source of rotational energy. This could be a small dynamo that is also within the vacuum chamber, or it could be a system that is magnetically or physically coupled to some source of rotational energy outside the main motor generator containment, or it could be some other method for supplying a small rotational impulse to the system.

One way to understand the operation of the variable capacitance electrostatic motor/generator is in terms of the energy stored on a capacitor. That amount of charge on a capacitor is defined by Q=CV where Q is charge, C is capacitance, and V is voltage. In the case of a variable capacitor the value of C can change. If the value of the variable capacitor is at a minimum and a given charge and voltage is place on to the capacitor and then the variable capacitor is allowed to assume a greater capacitance, the amount of charge stored on that capacitor will remain the same, but the voltage will drop as the capacitance rises. This allows the system to move into a lower-energy state and so some mechanical work will be done by the capacitor to achieve this lower-energy state. Conversely, if some charge at a low voltage is added to the variable capacitor in its maximum-capacitance state, and then the value of the variable capacitor is driven to decrease, the amount of charge will state the same, but the voltage on the capacitor will increase and the system will move into a high-energy state. In order to achieve this high-energy state, some work will have to be done to move the variable capacitor from its maximum capacitance position into its minimum capacitance position.

In the Philp Floating Rotor Variable Capacitance Machine, only the generation side of this phenomenon is utilized. As the variable capacitor is reaches a maximum, the voltage on the capacitor can drop below ground. When this occurs, charge is drawn on to the capacitor through the ground diode until the capacitor reaches that maximum. The variable capacitor then begins decreasing in capacitance and the voltage on the capacitor rises until it reaches the output voltage of the device. Once this has happened charge flows through high-side diode until the capacitor reaches its minimum value and the rotational energy that has been supplied to the generator rotor is transferred in the form of electrical potential to the output of the device. The variable capacitor then starts moving towards its maximum value again and the voltage of on the capacitor falls until is reaches a value low enough to once again draw charge through the low-side diode.

In the motor/generator invention described in this document, this process can also be reversed. When the variable capacitor is at its minimum value, or just past it and on its way towards its maximum, the high-side switch closes allowing high voltage charge to flow onto the capacitor. At some point before the maximum capacitance is reached the switch is opened, interrupting that flow. As the capacitor approaches its minimum value, the voltage of that charge falls reducing its electrical potential and converting that energy into useful rotational work. Once the voltage on the capacitor reaches the low-side voltage, or at some point before the voltage has a chance to rise beyond that low-side voltage, the low-side switch closes and allows charge to flow off of the capacitor. As the capacitor's value then decreases, the low-side switch remains closed so that the voltage on the capacitor remains low and no rotational work is required (or at least very little; there will be some small inefficiency in the switch that requires a small amount of work to overcome). As the capacitor approaches its minimum, the low-side switch opens just before (or ideally at the same instant as) the high-side switch opens, allowing a new unit of high-voltage charge to flow from the high side onto the capacitor, and the cycle begins anew.

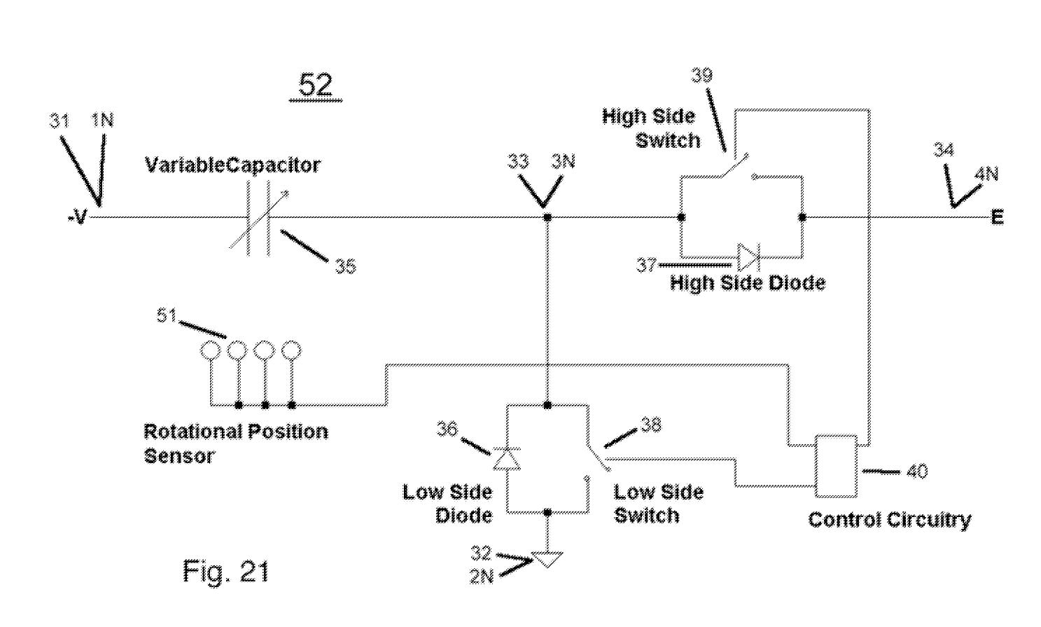

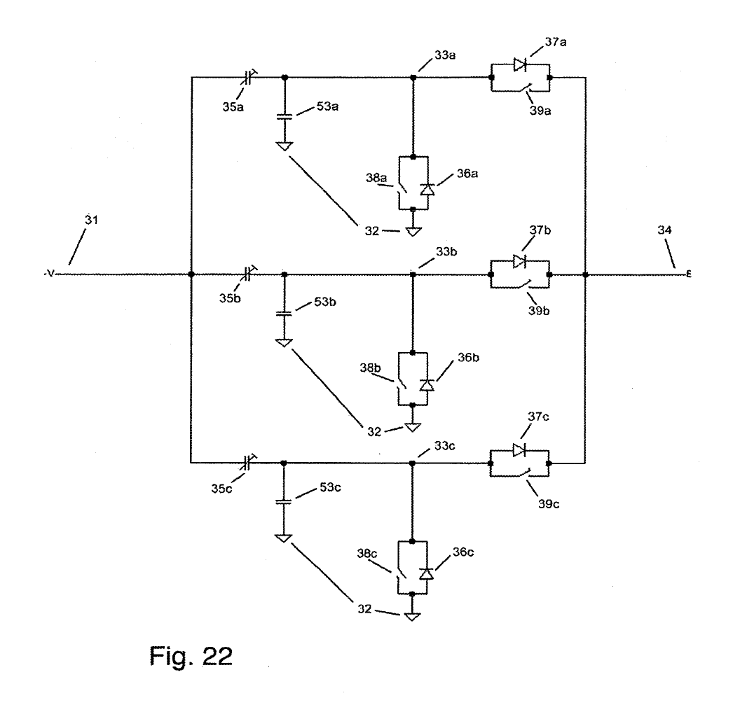

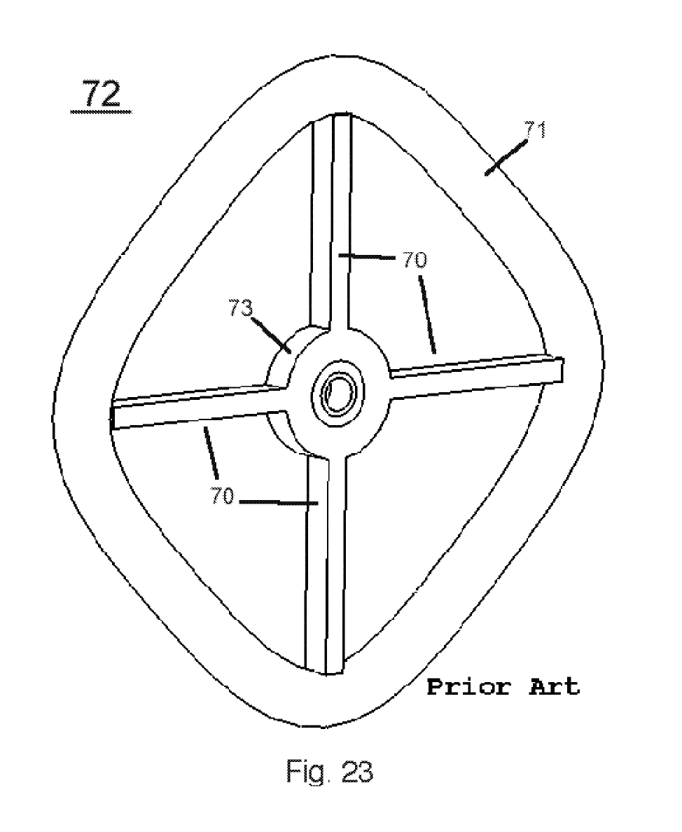

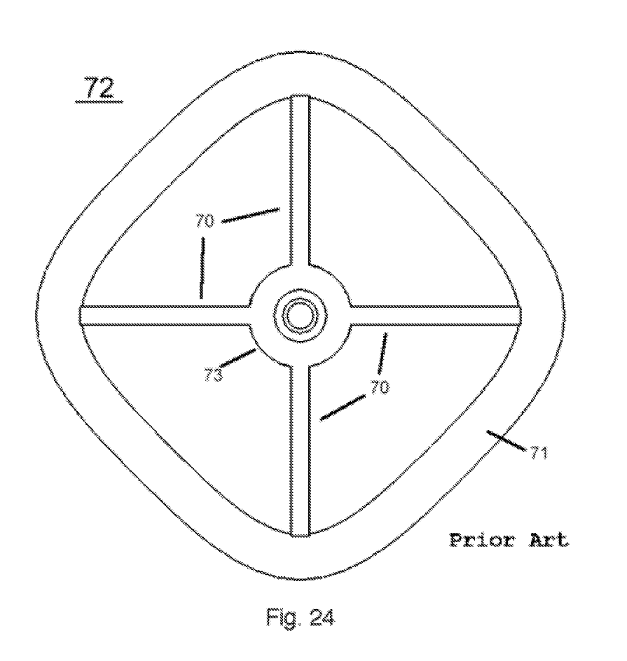

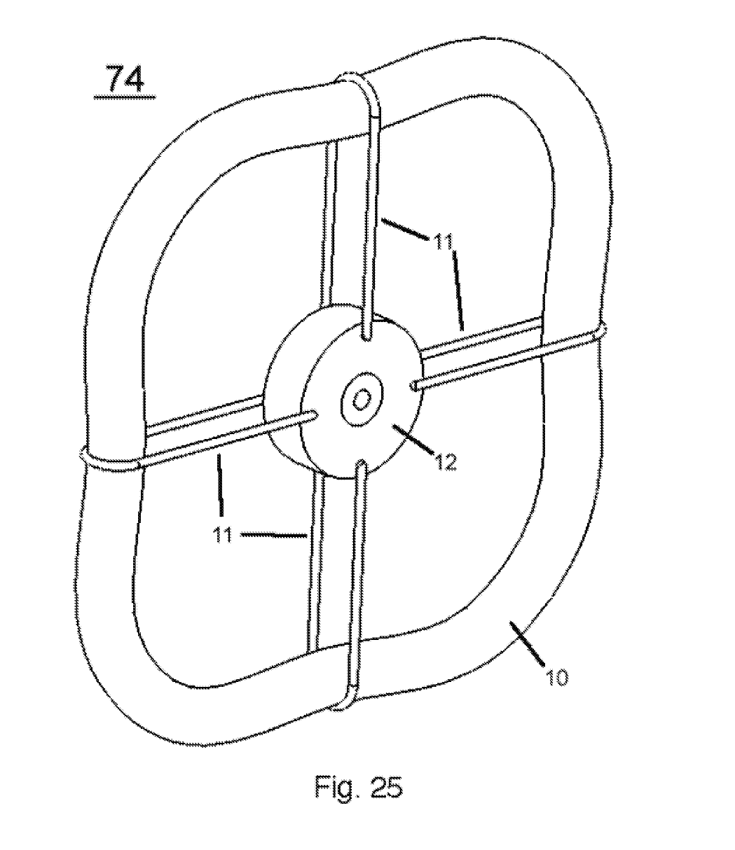

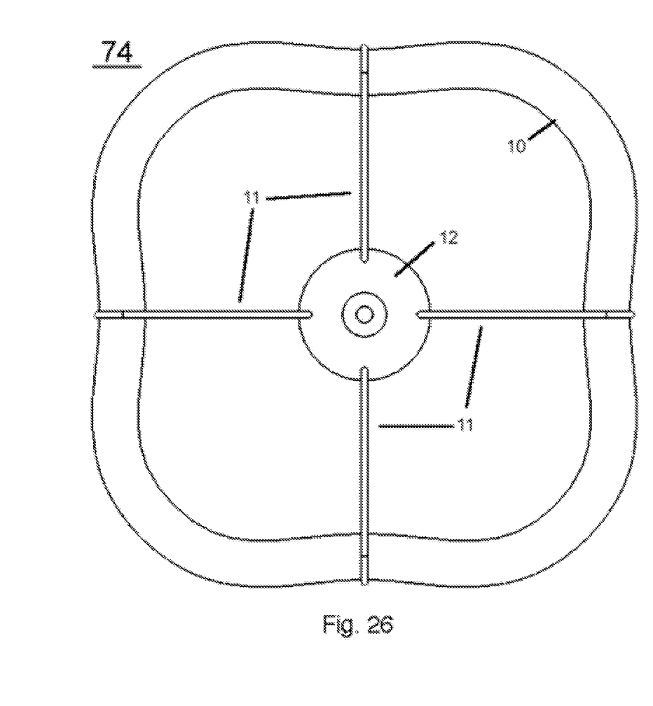

Turning to FIG. 21, what is shown in schematic form is electronics 52 for a motor-generator according to the invention.

In the case of a single-phase motor/generator, the electronics 52 appear once. In the case of a two-phase motor-generator, the electronics 52 appear once for each phase, having in common the first, second, and fourth nodes 31, 32, and 34. Each phase (rotor and stator) is represented by a corresponding variable capacitor 35.

Likewise in the case of a three-phase motor-generator, the electronics 52 again appear once for each phase, again having in common the first, second, and fourth nodes 31, 32, and 34.

For clarity of exposition, we commence with a characterization of the apparatus as a single-phase apparatus, and with its sequence of steps of operation so far as a single phase is concerned. It will be appreciated that the discussion applies mutatis mutandis to second, third, and additional phases if present.

The motor/generator apparatus thus comprises a conductive rotor and a conductive stator, the rotor rotatable on a shaft with respect to the stator, the rotor and stator defining a capacitance 35. The capacitance 35 is variable between maxima and minima as a function of rotation of the shaft, the capacitance defining first and second terminals. As is clear from context, given that the shaft in many embodiments is connected to a flywheel, the shaft is rotatable through a full rotation.

The motor-generator apparatus can be described with respect to first, second, third, and fourth electrical nodes 31, 32, 33 and 34. The first terminal of the variable capacitance 35 is electrically connected with the first node 31. The second terminal of the variable capacitance 35 is electrically connected with the third node 33. A first diode 36 (here sometimes termed a “low-side diode”) is connected between the second node 32 and the third node 33. A second diode 37 (here sometimes termed a “high-side diode”) is connected between the third and fourth nodes 33 and 34. A first switch 38 is connected between the second and third nodes 32 and 33, and a second switch 39 is connected between the third and fourth nodes 33 and 34.

We can then characterize a typical sequence of steps in which the motor-generator first acts as a motor, and later acts as a generator. Of course in exemplary embodiments discussed herein, the motor-generator serves as a motor to spin up a flywheel, and serves as a generator to extract energy from the flywheel.

During the mode of operation in which the motor-generator is serving as a motor, the typical sequence of steps is:
a first DC voltage is applied to the first node 31 relative to the second node 32;
a second DC voltage is applied to the fourth node 34 relative to the second node 32, the second DC voltage being opposite polarity to the first DC voltage with respect to the second node 32;
at a first time when the variable capacitance 35 is at a first capacitance that is not at its maximum, the second switch 39 is closed;
at a second time, after the first time, when the variable capacitance 35 is at a second capacitance that is higher than the first capacitance, and when a voltage across the variable capacitance is at a first potential, the second switch 39 is opened;
at a third time, after the second time, when the potential across the variable capacitance 35 is at a second potential lower than the first voltage, and when the capacitance is at a third capacitance, the first switch 38 is closed;
at a fourth time, after the third time, when the capacitance is at a fourth capacitance, the first switch 38 is opened.

In this way, the electrical energy applied to the apparatus via the first, second, and fourth nodes 31, 32, and 34 is converted to torque at the shaft.

During “motor” mode it should not happen that both of switches 38, 39 be closed at the same time.

The motor-generator is at some later time used as a generator. It will be appreciated, however, that depending on the application of the motor-generator, it may be desirable to permit the system (e.g. the flywheel) to “coast”. During coasting time, it may be desirable to permit one terminal of the variable capacitor, or the other terminal of the capacitor, to “float”. Alternatively, it may be desirable to ground both terminals of the variable capacitor.

Still another way to permit “coasting” is simply to open switches 38, 39 and to arrange for the voltage at 34 to be higher than the voltage developed at 33 (strictly speaking, for the relative voltages at 33 and 34 to be such that diode 37 does not conduct). Under such a circumstance the variable capacitor does not apply any net torque to the rotor shaft. If the shaft is mechanically coupled to a flywheel, the flywheel “coasts.”

When it is desired to operate in “generator” mode, both of the first and second switches are opened. Excitation voltage is provided at 31. DC voltage of varying magnitude is developed at 33, and if diode 37 conducts, the developed voltage and charge is passed to node 34.

In this way, torque applied to the rotor shaft causes the rotor to rotate relative to the stator, and mechanical energy applied to the shaft may be converted to electrical energy delivered at the fourth node.

In the embodiments illustrated here, the first diode 36 conducts electricity in the direction from the second node 32 to the third node 33, the second diode 37 conducts electricity in the direction from the third node 33 to the fourth node 34, and the first DC voltage at 31 is negative relative to the second node 32, arbitrarily designated as “ground”. Of course these polarities arc arbitrary and the entire system could operate with opposite polarities or at a “ground” potential that is significantly different than earth ground.

One can then generalize to a number of phases greater than one. Thus for example the apparatus can further comprise a second phase, the second phase comprising a second-phase rotor and second-phase stator connected with respective second-phase switches and second-phase diodes with respect to a second-phase third node, the second phase connected to the first, second, and fourth nodes 31, 32, and 34. In such apparatus the steps of the method are also carried out with respect to the second phase.

Likewise the apparatus may further comprise a third phase, the third phase comprising a third-phase rotor and third-phase stator connected with respective third-phase switches and third-phase diodes with respect to a third-phase third node, the third phase connected to the first, second, and fourth nodes 31, 32, and 34. In such apparatus the steps of the method are also carried out with respect to the third phase.

Further phases could also be provided as desired.

It will also be appreciated that even in a single-phase design, there could be multiple poles. In a multiple-pole configuration, the opening and closing of switches 38, 39 is carried out exactly as described (relative to higher and lower values of capacitance etc.) but it happens more than once per physical revolution of the shaft.

Returning to FIG. 21, there is shown control circuitry 40 which controls switches 38, 39. The control circuitry 40 carries out its activities with respect to rotational position sensor 51. In an exemplary embodiment the rotor has shiny parts along its periphery, which are detected by LED-phototransistors, thereby permitting control circuitry 40 to turn the switches 38, 39 on and off at the correct times to drive the motor.

It will be appreciated that in the most general sense, to operate apparatus 52 in “motor” mode requires nothing more than that the relative potential between nodes 31 and 33 be a waveform suited to “kick” the rotor so as to continue to rotate (or to rotate faster). Switches 38 and 39, and the potentials at nodes 31, 32, 34 as described, can (with the help of control electronics 40) provide just such a waveform. But anything that provides a waveform at nodes 31 and 33 that “kicks” the rotor to rotate, will cause the apparatus to serve as a motor (converting electrical energy to rotational mechanical energy).

Currently the motor generator described in this document has only vacuum between the motor/generator rotor plates and the stator plates for insulation purposes. A dielectric coating or a variable dielectric coating can also be added and may increase the total voltage the motor/generator can operate from without experiencing electrical breakdown increasing the total power available from a unit of given size. Additionally, a variable dielectric may be used to increase the maximum capacitance and the total variability of the capacitance of the system. Either of these contributions would also increase the potential power available for a motor of a specific configuration. Presently strictly vacuum insulated system is thought to be optimal from a cost/power perspective.

In the exemplary embodiment of FIG. 4 the terminology “2-pole” may be used to connote that each rotation of the motor/generator rotor gives rise to two maxima and two minima of capacitance.

The number of poles in such an electrostatic system can be quite variable, but generally more power can be developed at a given speed by motors using a larger number of poles. There are constraints on the number of poles that can be accommodated in a design. The optimization process is described in Christopher Lee Rambin “The Optimized Electrostatic Motor” Dissertation Presented to the College of Engineering and Science Louisiana State University May 1998. This document contains several errors but is useful in many respects. The primary constraints on the number of poles are the smallest feature size manufacturable using the fabrication method chosen, the spacing between the motor/generator rotor and stator plates, and the maximum frequency of the switching device that is used to drive the electro-static motor. The maximum switching frequency will limit the ultimate rotational speed or rpms that the motor can attain. Given a set maximum switching frequency a motor with a lower number of poles will be able to attain a higher ultimate speed. If a given maximum rotational speed is required by a design, then the maximum switching speed and the maximum number of poles must be optimized to that desired rotational speed.

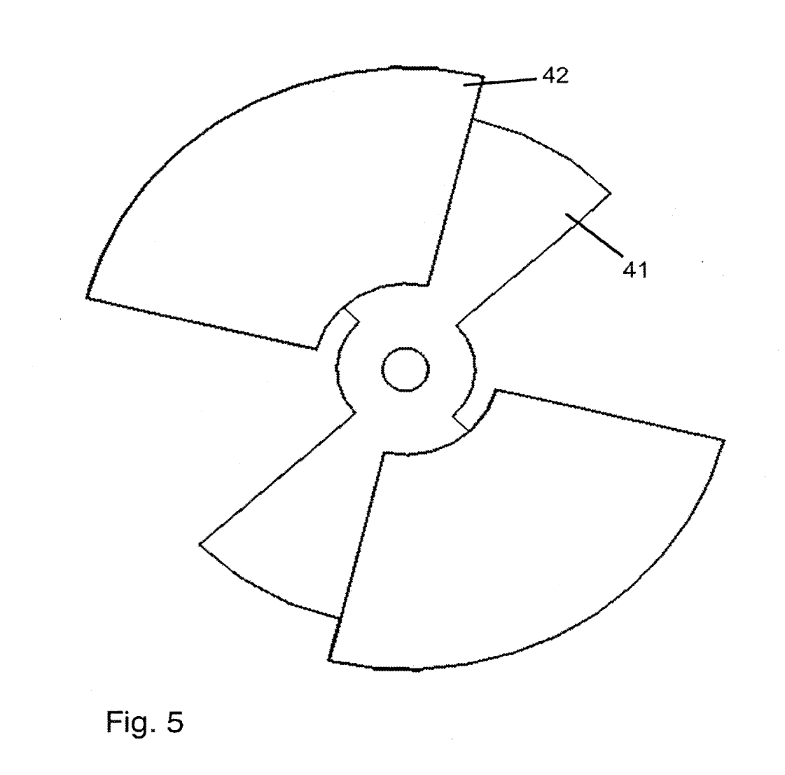

FIG. 5 shows the same motor/generator rotor and stator of FIG. 4, in plan view.

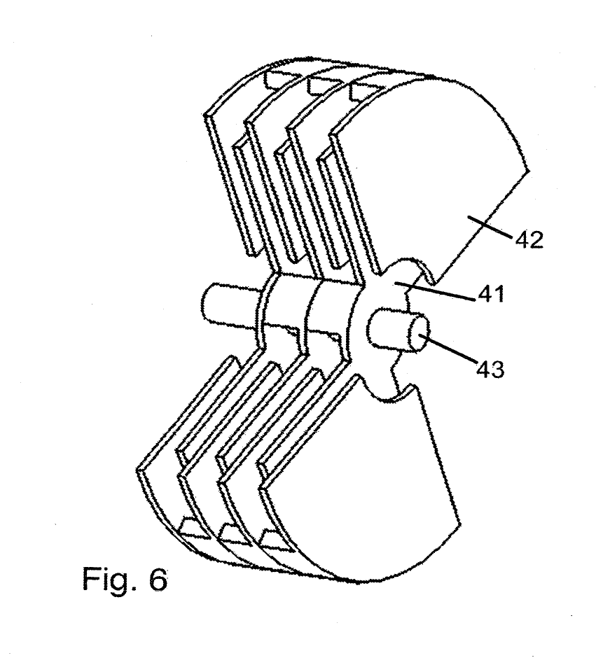

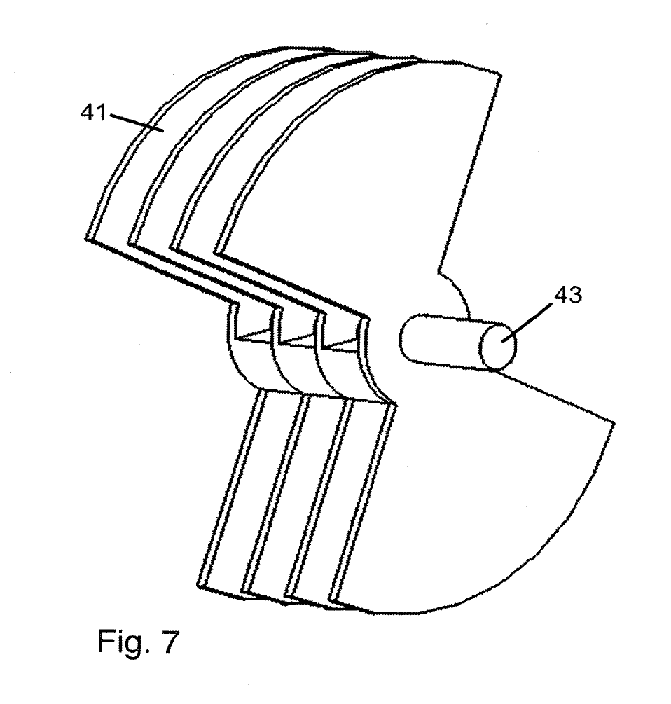

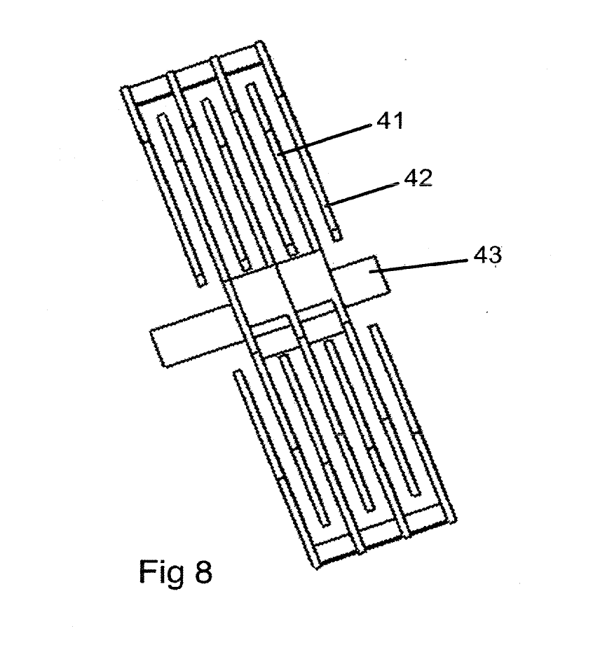

FIG. 6 shows in perspective view two-pole motor/generator rotors and stators such as in FIGS. 4-5, stacked on a shaft 43. For each pole there are four stator plates 42 and three motor/generator rotor plates 41. FIG. 7 shows in perspective view the motor/generator rotor 41 and shaft 43 of FIG. 6. FIG. 8 shows in cross-section view the four stator plates 42 and three motor/generator rotor plates 41 and shaft 43 of FIG. 6.

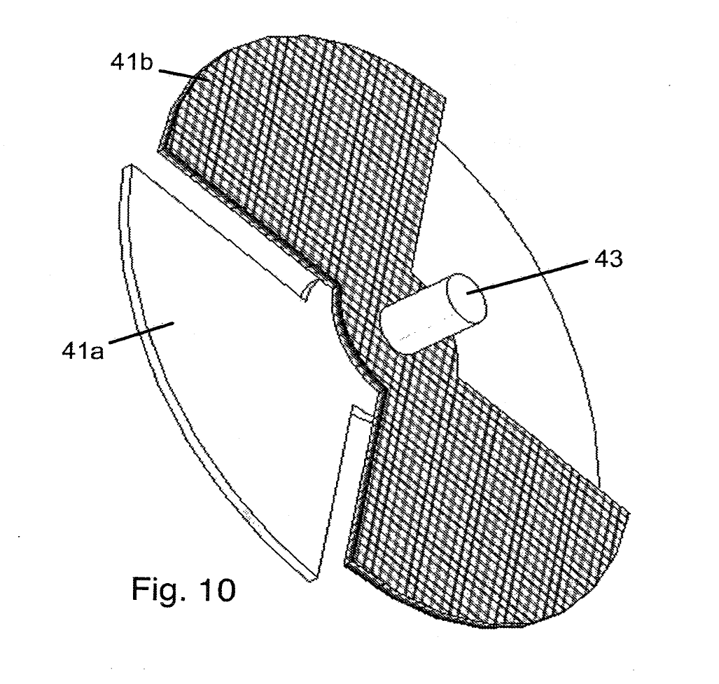

FIG. 10 shows in perspective view a motor/generator rotor with plates 41a, 41b on shaft 43. This motor/generator rotor may be termed a “two-phase” motor/generator rotor meaning that the plates 41a and 41b are mechanically ninety degrees out of phase with each other. Their electrical phase relationship cannot be fully determined without an understanding of the stator arrangement. It is also a two-pole motor/generator rotor meaning (as above) that a single rotation of the motor/generator rotor gives rise to two minima and two maxima of capacitance.

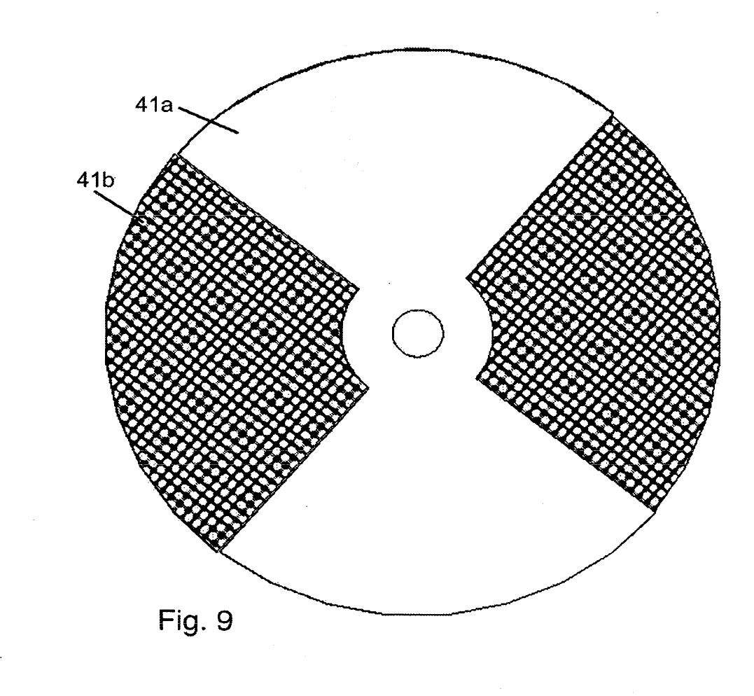

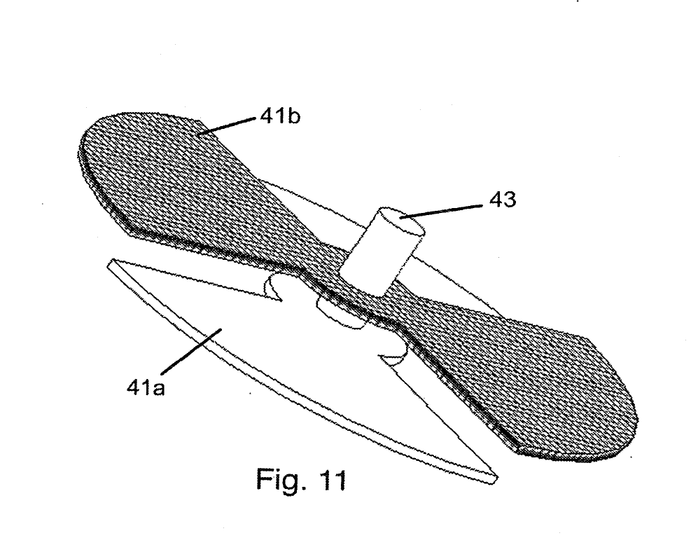

Omitted for clarity in FIG. 10 are the stators, which are also disposed in two phases, corresponding to the phases of plates of the motor/generator rotors. FIG. 11 is a different perspective view of the motor/generator rotor of FIG. 10, and FIG. 9 is a plan view showing the plates 41a and 41b of the motor/generator rotor of FIG. 10.

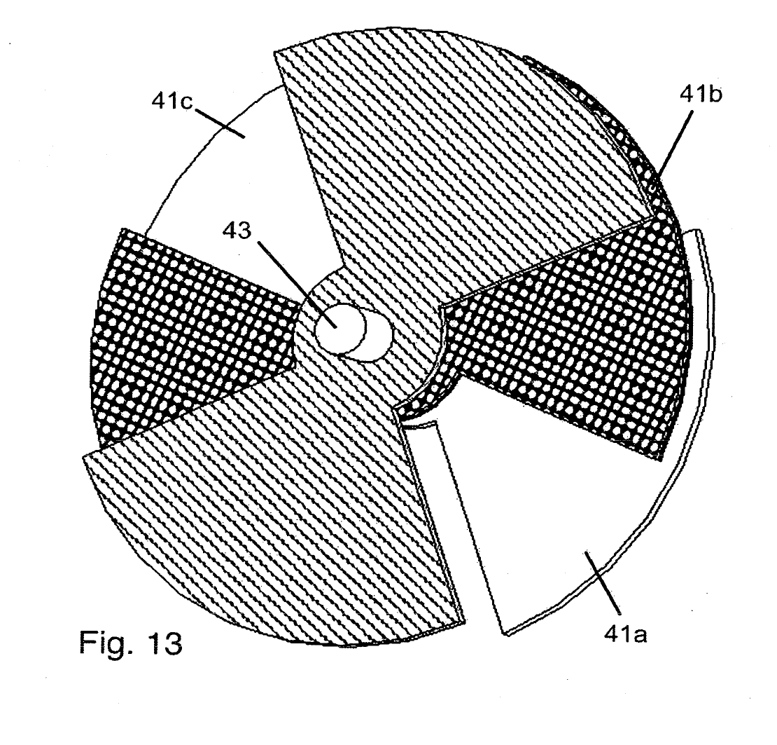

FIG. 13 shows in perspective view a motor/generator rotor with plates 41a, 41b, 41c on shaft 43. This motor/generator rotor may be termed a “three-phase” motor/generator rotor meaning that the plates 41a and 41b are sixty degrees out of phase with each other and the plates 41b and 41c are mechanically sixty degrees out of phase with each other. It is also a two-pole motor/generator rotor meaning (as above) that a single rotation of the motor/generator rotor gives rise to two minima and two maxima of capacitance in each phase.

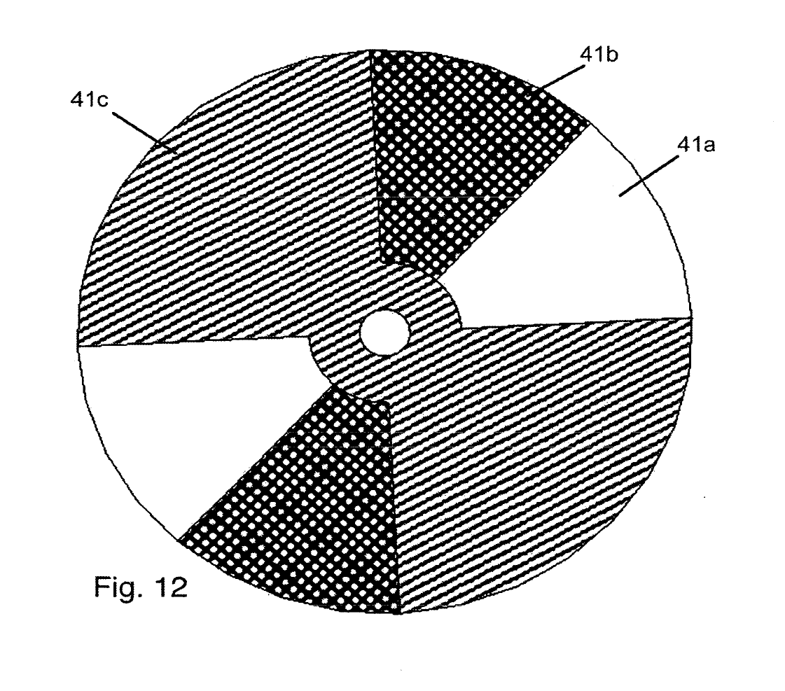

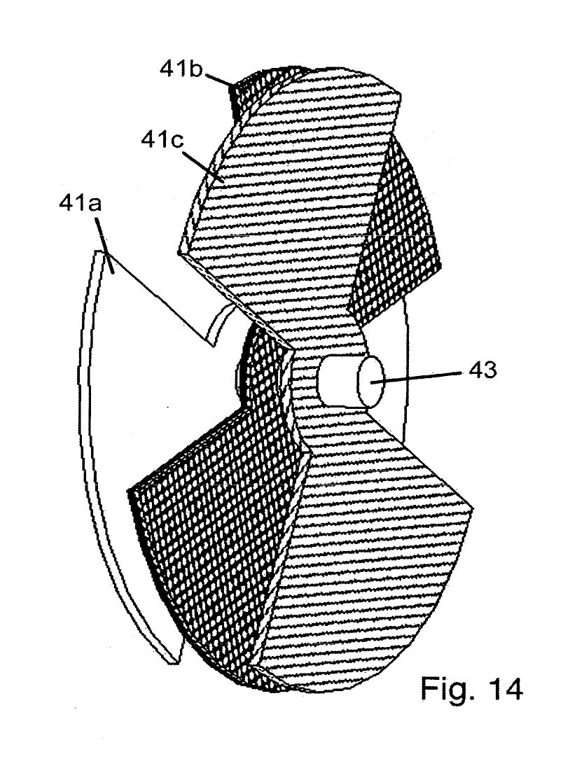

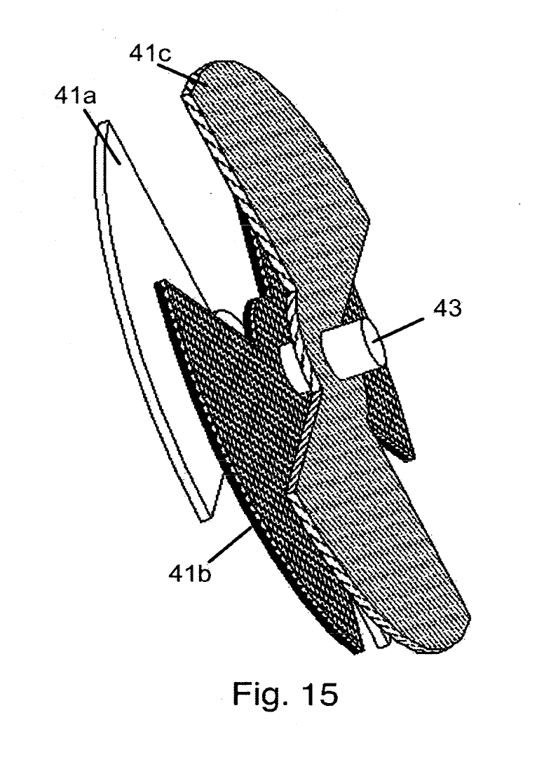

Omitted for clarity in FIG. 13 are the stator plates, which are can also be disposed in three phases. Generally, either the motor/generator rotor will be mechanically phased or the stator will be mechanically phased so as to achieve electrical phase angles, though mechanically phasing both motor/generator rotor and stator in certain circumstances may be desirable. FIG. 14 is a different perspective view of the motor/generator rotor of FIG. 13, and FIG. 12 is a plan view showing the plates 41a, 41b and 41c of the motor/generator rotor of FIG. 13. FIG. 15 is yet another perspective view of the motor/generator rotor of FIG. 13.

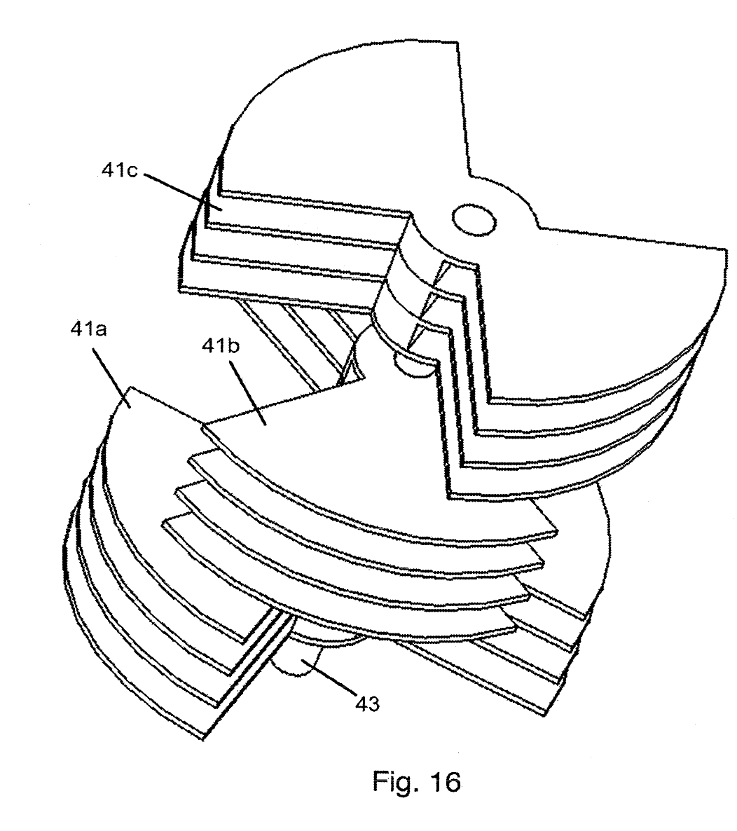

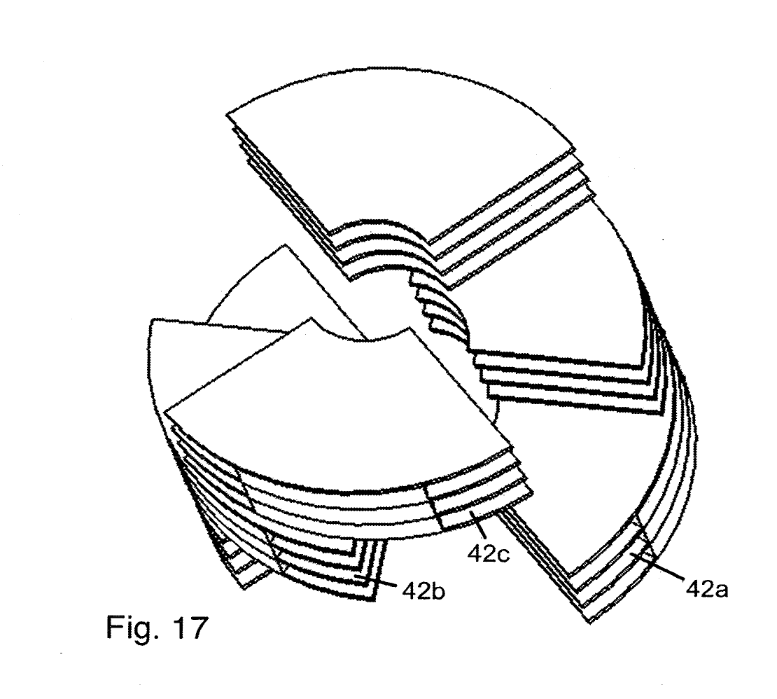

In exemplary embodiment the motor/generator rotor is a stack, as shown in FIG. 16, with plates 41a, 41b, and 41c disposed in three phases about shaft 43. As was mentioned above, omitted for clarity in FIG. 16 were the stators. In FIG. 17 may be seen stacked stator plates 42a, 42b, and 42c which can also be used to create electrical phase angles. The stator plates 42a, 42b, and 42c are disposed in three phases, as may be seen in perspective view in FIG. 17.

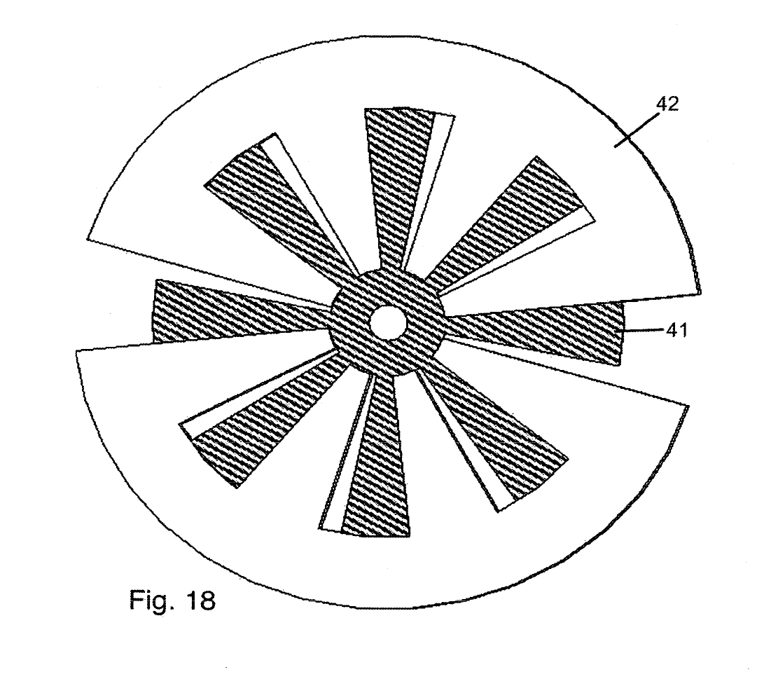

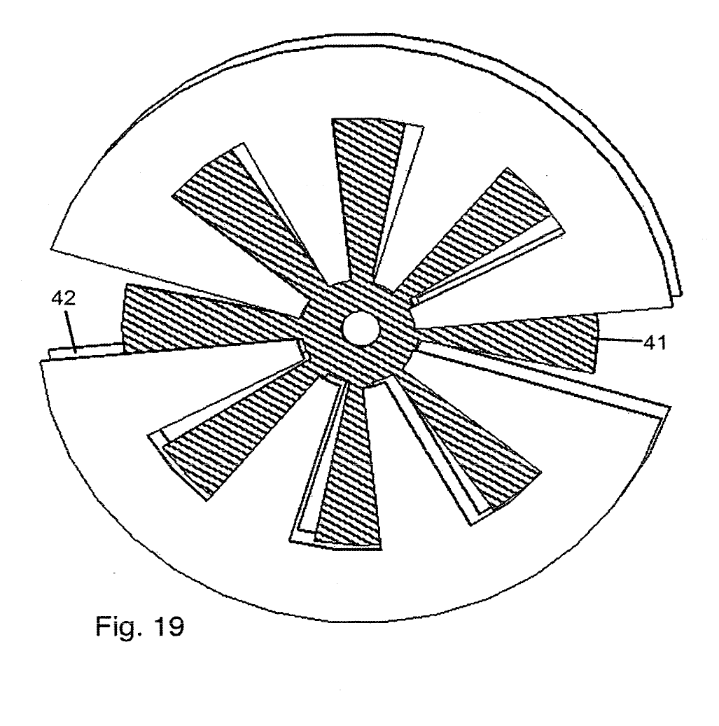

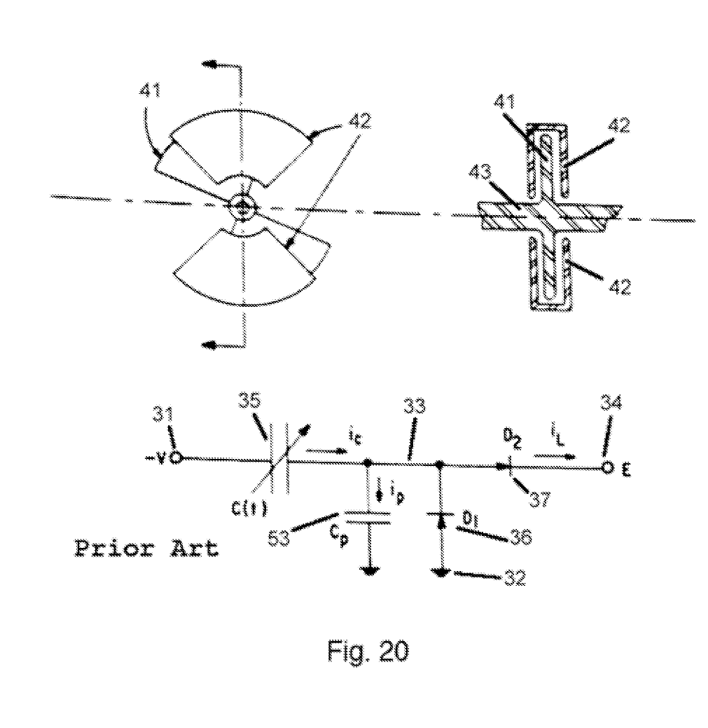

Larger numbers of poles may also be employed. FIG. 19 shows in perspective view a motor/generator rotor plate 41 with eight lobes, and a stator plate 42 with four lobes. FIG. 18 shows the system of FIG. 19 but in plan view.

The numbers of poles may be larger than eight, and numbers of poles larger than eight are thought to be preferable. The more poles, the more power the motor can provide, and this suggests the number of poles should be larger rather than smaller.

There are, however, several limiting factors on the number of poles. First, the smallest feature size of a pole must be at least 1.5 times (approximately) the size of the gap between the motor/generator rotor and stator, otherwise one loses variability in the capacitor as the capacitance starts to bleed off the edges of the poles and one ends up with a lot of parasitic capacitance.

Also, the more poles one employs, the faster one must switch the high voltages on and off to attain a given rpm of motor rotation.

It is thought that an optimal number of poles will be nearer to 100 poles than 8.

The choice of the number of phases is also a subject for optimization. Two phases are thought to be workable in the present application, although three phases are thought to be optimal. More phases could be used. If starting the motor from any given stationary position was to be handled in some other way, or only the generation capability where to be implemented, a single phase system would be just fine in most applications.

Those skilled in the art will have no difficulty devising myriad obvious variations and improvements to a switch capable of efficiently switching high voltages at reasonably high frequencies, all of which are intended to be encompassed within the scope of the claims which follow. Stacked IGBT or Mosfet switches like those disclosed in W. Jiang “Fast High Voltage Switching Using Stacked Mosfets” IEEE Transactions on Dielectrics and Electrical Insulation, Vol. 14 Issue: August 2007 pages 947-950, J. W. Baek, D. W. Yoo, H. G. Kim “High Voltage Switch Using Series-Connected IGBTs with Simple Auxiliary Circuit” Industry Applications Conference 2000. Conference Record of the 2000 IEEE, Vol. 4 Oct. 2000 pages: 2237-2242, and many other published articles and books can be made to work well in this application. Presently, the stacked IGBT type switch appears to provide the best performance and efficiency at a relatively low cost and is readily fabricated out of generally available components, but many other types of well known switches can be used in conjunction with the motor/generator as described, and it is assumed that other less well known, or yet to be invented, switching devices can be used.

It should also be noted that in all of our investigations the motor/generator and flywheel share the same main bearing system. This has been done as a matter of convenience and economy and the inventor is not aware of any specific reason that any other arrangement in which additional main bearings are used or motor/generator and flywheel rotor bearings are disaggregated, would be preferable, but such configurations are certainly possible and are intended to be encompassed within the scope of the claims that follow. Furthermore it should be noted that a very wide variety of bearing technologies can be implemented as the main bearing in this system and that each bearing technology will have its own pluses and minuses. Currently, we are favoring a standard non-contact passive/active hybrid magnetic bearing for this application.

1. A method for use with a chamber containing a motor-generator and an approximately toroidal flywheel rotor, the flywheel rotor having a mass, substantially all of the mass of the flywheel rotor comprising fibers, the fibers in large part movable relative to each other, the chamber further containing a hub, the flywheel rotor positioned around and bound to the hub by tensile stringers, the stringers each of a radius slightly smaller than the outer radius of the flywheel rotor, the hub suspended from a shaft, the shaft either having some non-negligible flexibility normal to the axis of rotation or a rigid shaft being suspended by a joint flexible normal to the axis of rotation such as a universal joint, the flexible shaft or universal joint suspended by the shaft of a motor-generator,
the method comprising the steps of:
evacuating the chamber,
supplying electrical energy to the motor-generator, thereby causing the motor-generator to apply torque via the shaft or shaft/joint combination to the hub, thereby causing the flywheel rotor to rotate, thereby causing the stringers to come under tension,
thereafter, ceasing the supply of electrical energy to the motor-generator,
thereafter, extracting energy from the spinning flywheel rotor by means of the motor-generator, yielding electrical energy.

2. The method of claim 1 wherein the flywheel rotor has an angular velocity, the angular velocity exceeding 1 Hertz.

3. The method of claim 1 wherein an interval passes between the ceasing of the supply of electrical energy and the extraction of energy, the interval exceeding 1 minute.

4. The method of claim 1 wherein the rotation of the flywheel rotor defines a quantity of stored energy, and wherein the quantity of stored energy exceeds 1 joule.

5. The method of claim 1 wherein the evacuation of the chamber gives rise to a vacuum of at least 10″3 Torr.

6. The method of claim 1 wherein the motor-generator comprises at least one capacitor defined by a motor/generator rotor plate and a stator plate, the motor/generator rotor plate mechanically coupled to the shaft and the stator plate mechanically coupled to the gimbal, the motor/generator rotor plate and stator plate electrically connected to drive electronics.

7. A method for use with apparatus comprising a conductive rotor and a conductive stator, the rotor rotatable on a shaft with respect to the stator, the rotor and stator defining a capacitance variable between maxima and minima as a function of rotation of the shaft, the capacitance defining first and second terminals, the shaft rotatable through a full rotation, the apparatus defining first, second, third, and fourth electrical nodes, the first terminal of the variable capacitance electrically connected with the first node, the second terminal of the variable capacitance electrically connected with the third node, a first diode connected between the second node and the third node, a second diode connected between the third and fourth nodes, a first switch connected between the second and third nodes, and a second switch connected between the third and fourth nodes, the method comprising two modes of operation, the steps of the first mode comprising:
applying a first DC voltage to the first node relative to the second node;
applying a second DC voltage to the fourth node relative to the second node, the second DC voltage being opposite polarity to the first DC voltage with respect to the second node;
at a first time when the variable capacitance is at a first capacitance that is not at its maximum, closing the second switch;
at a second time, after the first time, when the variable capacitance is at a second capacitance that is higher than the first capacitance, and when a voltage across the variable capacitance is at a first potential, opening the second switch;
at a third time, after the second time, when the potential across the variable capacitance is at a second potential lower than the first voltage, and when the capacitance is at a third capacitance, closing the first switch;
at a fourth time, after the third time, when the capacitance is at a fourth capacitance, opening the first switch;
whereby the electrical energy applied to the apparatus is converted to torque at the shaft during the first mode;
the steps of the second mode comprising:
at a fifth time, after the fourth time, opening the first and second switches;
applying torque to the shaft, thereby causing the rotor to rotate relative to the stator;
whereby mechanical energy applied to the shaft is converted to electrical energy at the fourth node during the second mode.

8. The method of claim 7 wherein the first diode conducts electricity in the direction from the second node to the third node, and wherein the second diode conducts electricity in the direction from the fourth node to the third node, and wherein the first DC voltage is negative at the first node relative to the second node.

9. The method of claim 7 wherein the apparatus further comprises a second phase, the second phase comprising a second-phase rotor and second-phase stator connected with respective second-phase switches and second-phase diodes with respect to a second-phase third node, the second phase connected to the first, second, and fourth nodes,
wherein the steps of the method are also carried out with respect to the second phase.

10. The method of claim 9 wherein the apparatus further comprises a third phase, the third phase comprising a third-phase rotor and third-phase stator connected with respective third-phase switches and third-phase diodes with respect to a third-phase third node, the third phase connected to the first, second, and fourth nodes,
wherein the steps of the method are also carried out with respect to the third phase.

11. Apparatus comprising a conductive rotor and a conductive stator, the rotor rotatable on a shaft with respect to the stator, the rotor and stator defining a capacitance variable between maxima and minima as a function of rotation of the shaft, the capacitance defining first and second terminals, the shaft rotatable through a full rotation, the apparatus defining first, second, third, and fourth electrical nodes, the first terminal of the variable capacitance electrically connected with the first node, the second terminal of the variable capacitance electrically connected with the third node, a first diode connected between the second node and the third node, a second diode connected between the third and fourth nodes, a first switch connected between the second and third nodes, and a second switch connected between the third and fourth nodes.

12. The apparatus of claim 11 wherein the first diode conducts electricity in the direction from the second node to the third node, and wherein the second diode conducts electricity in the direction from the third node to the forth node.

13. The apparatus of claim 11 wherein the apparatus further comprises a second phase, the second phase comprising a second-phase rotor and second-phase stator connected with respective second-phase switches and second-phase diodes with respect to a second-phase third node, the second phase connected to the first, second, and fourth nodes.

14. The apparatus of claim 13 wherein the apparatus further comprises a third phase, the third phase comprising a third-phase rotor and third-phase stator connected with respective third-phase switches and third-phase diodes with respect to a third-phase third node, the third phase connected to the first, second, and fourth nodes.

15. The apparatus of claim 11 wherein the switches of the apparatus are controlled by circuitry that takes input from a method of rotary position detection focused on the rotary position of the rotor.

16. The apparatus of claim 11 further comprising a massive rotor centrally suspended from a shaft, the shaft being flexible in itself or being suspended from a flexible joint, the flexible shaft or flexible joint being suspended from the rotor, the stator being suspended from a damped gimbal.

17. The apparatus of claim 16 wherein the system is contained in a chamber evacuatable to vacuum.

18. A method for use with apparatus comprising a conductive rotor and a conductive stator, the rotor rotatable on a shaft with respect to the stator, the rotor and stator defining a capacitance variable between maxima and minima as a function of rotation of the shaft, the capacitance defining first and second terminals, the shaft rotatable through a full rotation, the apparatus defining first, second, third, and fourth electrical nodes, the first terminal of the variable capacitance electrically connected with the first node, the second terminal of the variable capacitance electrically connected with the third node, a first diode connected between the second node and the third node, a second diode connected between the third and fourth nodes, and a waveform source connected between the first and third nodes, the method comprising the steps of:
applying a waveform from the waveform source so as to cause the rotor to rotate;
whereby the electrical energy applied to the apparatus is converted to torque at the shaft;
at a later time, ceasing the application of the waveform from the waveform source and applying a first DC voltage at the first node relative to the second node;
applying torque to the shaft, thereby causing the rotor to rotate relative to the stator;
whereby mechanical energy applied to the shaft is converted to electrical energy at the fourth node.

19. The method of claim 18 wherein the first diode conducts electricity in the direction from the second node to the third node, and wherein the second diode conducts electricity in the direction from the fourth node to the third node, and wherein the first DC voltage is negative at the first node relative to the second node.

20. The method of claim 18 wherein the apparatus further comprises a second phase, the second phase comprising a second-phase rotor and second-phase stator connected with a respective second-phase waveform source and second-phase diodes with respect to a second-phase third node, the second phase connected to the first, second, and fourth nodes;
wherein the steps of the method are also carried out with respect to the second phase.

21. The method of claim 20 wherein the apparatus further comprises a third phase, the third phase comprising a third-phase rotor and third-phase stator connected with a respective third-phase waveform source and third-phase diodes with respect to a third-phase third node, the third phase connected to the first, second, and fourth nodes,
wherein the steps of the method are also carried out with respect to the third phase.

22. Apparatus comprising a conductive rotor and a conductive stator, the rotor rotatable on a shaft with respect to the stator, the rotor and stator defining a capacitance variable between maxima and minima as a function of rotation of the shaft, the capacitance defining first and second terminals, the shaft rotatable through a full rotation, the apparatus defining first, second, third, and fourth electrical nodes, the first terminal of the variable capacitance electrically connected with the first node, the second terminal of the variable capacitance electrically connected with the third node, a first diode connected between the second node and the third node, a second diode connected between the third and fourth nodes, and a waveform source connected between the first and third nodes.

23. The apparatus of claim 22 wherein the first diode conducts electricity in the direction from the second node to the third node, and wherein the second diode conducts electricity in the direction from the fourth node to the third node.

24. The apparatus of claim 22 wherein the apparatus further comprises a second phase, the second phase comprising a second-phase rotor and second-phase stator connected with a respective second-phase waveform source and second-phase diodes with respect to a second-phase third node, the second phase connected to the first, second, and fourth nodes.

25. The method of claim 24 wherein the apparatus further comprises a third phase, the third phase comprising a third-phase rotor and third-phase stator connected with a respective third-phase waveform source and third-phase diodes with respect to a third-phase third node, the third phase connected to the first, second, and fourth nodes.

26. The apparatus of claim 22 further comprising a massive rotor centrally suspended from a shaft,
the shaft being flexible in itself or being suspended from a flexible joint, the flexible shaft or flexible joint being suspended from the shaft, the stator being suspended from a damped gimbal.

27. The apparatus of claim 26 wherein the system is contained in a chamber evacuatable to vacuum.
